(19) United States
(12) Patent Application Publication
(10) Pub. No.: US 2011/0303371 A1
(43) Pub. Date: Dec. 15, 2011

(54) SUNSHADE FOR USE WITH GOLF CARTS

(76) Inventor: THOMAS BRYANT HARRISON, AUSTIN, TX (US)

(21) Appl. No.: 12/567,168

(22) Filed: Sep. 25, 2009

(51) Int. Cl. B60J 3/02

(52) U.S. Cl. 160/370.21

(57) ABSTRACT

Embodiments provide a sunshade for use with a golf cart, the sunshade including fabric material supported for releasable engagement with a cart roof.

### FIELD OF THE INVENTION

The disclosure relates to sunshades for use with golf carts.

### BACKGROUND OF THE INVENTION

When playing golf, a golf cart can be used to transport players and bags of golf clubs around a golf course. A golf cart typically includes a pair of rear wheels mounted on a rear axle and a pair of steerable front wheels mounted along a common front wheel axis. The golf cart is propelled by operation of a suitable electric motor or small internal combustion engine. A golf cart includes a cart body supported by the wheels for travel across ground. The cart body has a front adjacent the front wheels and a rear adjacent the rear wheels. The cart body has opposite right and left sides extending between the front and rear. The cart body defines a passenger compartment intermediate the front and rear wheels. The passenger compartment is open and includes a suitable bench seat. The bench seat is sized to comfortably accommodate two adults seated side-by-side and facing in the forward direction. The cart body lacks passenger doors on both the right and left sides, so that passengers can step from the ground into the passenger compartment and seat themselves on the bench seat, or vice-versa, without operating a passenger door. The cart body includes a right seat arm rail supported at the right end of the bench seat and a left seat arm rail supported at the left end of the bench seat. The cart body includes a bench seat back. In some arrangements, the bench seat back is formed in integral relation with a bench seat bottom. In other arrangements, the bench seat back is formed independent of the bench seat bottom and is supported in a fixed position to cooperate with the bench seat bottom to support the seated passengers. The cart body includes a golf bag well located at the rear of the cart, behind the bench seat back. In some arrangements, an equipment basket is supported between the bench seat back and the golf bag well. The golf bag well is open and sized to accommodate a pair of upright golf bags carrying golf clubs. The golf cart includes a cart roof which is supported in spaced relationship above the cart body. The golf cart includes a set of roof posts which support the cart roof above the cart body. Sunlight incident upon the golf cart below the cart roof can enter the open passenger compartment.

For reasons stated above, and for other reasons stated below which will become apparent to those skilled in the art upon reading and understanding the present specification, embodiments provide improved sunshades for use with golf carts. The above-mentioned shortcomings, disadvantages and problems are addressed herein, which will be understood by reading and studying this specification.

### SUMMARY OF INVENTION

Embodiments provide improved sunshades for use with golf carts. Apparatus and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a right side perspective view showing a sunshade according to a first embodiment installed on a golf cart.

FIG. 2 is an enlarged partial right side perspective view showing the sunshade according to a first embodiment installed on a golf cart as generally shown in FIG. 1.

FIG. 3 is a partial right side perspective view showing the sunshade according to a first embodiment installed on a golf cart and taken generally along line 3-3 in FIG. 1.

FIG. 4 is a partial isolation right side perspective view of the sunshade according to a first embodiment.

FIG. 5 is an enlarged partial right side perspective view of the sunshade according to a first embodiment as shown generally in FIG. 1, and showing detail of a third releasable fastener wrapped and fastened around a right arm rail of the golf cart during installation of the sunshade.

FIG. 6 is an enlarged partial right side perspective view similar to FIG. 5 and showing detail of the sunshade according to a first embodiment, showing a third releasable fastener wrapped around a right arm rail and aligned to be fastened during installation of the sunshade on the golf cart.

FIG. 7 is a partial view taken generally along line 7-7 in FIG. 6 and showing detail of the sunshade according to a first embodiment including a third releasable fastener wrapped around and aligned prior to being fastened during installation of the sunshade on the golf cart.

FIG. 8 is an enlarged partial perspective view of the sunshade according to a tenth embodiment, and showing detail of a first releasable fastener of same.

FIG. 9 is an enlarged partial right side perspective view showing the sunshade according to a first embodiment as generally shown in FIG. 2, and showing detail of a second releasable fastener secured to a golf cart in an alternate position.

FIG. 10 is a right side perspective view showing a sunshade according to a second embodiment installed on a golf cart.

FIG. 11 is an upper interior perspective view of the sunshade according to a second embodiment installed on a golf cart as generally shown in FIG. 10 and showing an opposing surface of the sunshade, with hidden detail of releasable fasteners of same being shown in phantom lines.

FIG. 12 is a left side perspective view showing a sunshade according to a third embodiment installed on a golf cart.

FIG. 13 is a top view taken generally along 13-13 in FIG. 12 and showing the sunshade according to a third embodiment installed on a golf cart.

FIG. 14 is a left side perspective view showing a sunshade according to a fourth embodiment installed on a golf cart.

FIG. 15 is a left side perspective view showing a sunshade according to a fifth embodiment installed on a golf cart.

FIG. 16 is an upper interior perspective view of the sunshade according to a fifth embodiment installed on a golf cart as generally shown in FIG. 15 and showing a portion of an opposing interior surface of the sunshade and detail of a releasable fastener of same.

FIG. 17 is a left side perspective view showing a sunshade according to a sixth embodiment installed on a golf cart.

FIG. 18 is a left side perspective view similar to FIG. 17, showing the sunshade according to a sixth embodiment installed on a golf cart and showing hidden details of the golf cart in phantom lines.

FIG. 19 is an enlarged partial isolation view of a sunshade according to a sixth embodiment as shown generally in FIG. 17, and showing detail of a first releasable mounting bracket.

FIG. 20 is an enlarged partial right side perspective view of the sunshade according to a sixth embodiment as shown generally in FIG. 17, and showing detail of a second releasable mounting bracket.

FIG. 21 is an enlarged partial right side perspective view of the sunshade according to a sixth embodiment as shown generally in FIG. 17, and showing further detail of the second releasable mounting bracket and a second releasable fastener engaged with same.

FIG. 22 is an enlarged partial right side isolation view of the sunshade according to a tenth embodiment as shown generally in FIG. 8, and showing further detail of an alternative second releasable fastener of same.

FIG. 23 is a partial left interior perspective view of the sunshade according to a sixth embodiment as shown generally in FIG. 20, and showing upper interior details of the first releasable mounting bracket and second releasable mounting bracket below the cart roof, and showing interior surfaces of the sunshade.

FIG. 24 is a partial left interior perspective view of the sunshade according to a sixth embodiment as shown generally in FIG. 23, and showing upper interior details including a view of the second releasable mounting bracket below the cart roof, and showing an upper edge of the sunshade routed beneath the cart roof and around a right rear corner post.

FIG. 25 is a partial right side perspective view of the sunshade according to a sixth embodiment installed on a golf cart as shown generally in FIG. 20.

FIG. 26 is an enlarged partial interior perspective view showing an upper interior surface of a sunshade according to a seventh embodiment installed on a golf cart and showing hidden details of releasable fasteners of same in phantom lines along the rear edge and left roof edge of the cart roof.

FIG. 27 is a left side perspective view showing a sunshade according to an eighth embodiment installed in a first orientation on a golf cart.

FIG. 28 is a left side perspective view showing the sunshade according to an eighth embodiment and previously shown in FIG. 27, installed in a second orientation on a golf cart.

FIG. 29 is an enlarged partial perspective view showing further details of structure of the sunshade shown generally in FIG. 27.

FIG. 30 is an enlarged partial perspective view showing further details of structure of the sunshade shown generally in FIG. 29.

FIG. 31 is an enlarged partial perspective view showing details of structure of the sunshade shown generally in FIG. 30, before being installed on a golf cart.

FIG. 32 is an enlarged partial interior perspective view taken beneath the cart roof and showing details of structure of the sunshade according to an eighth embodiment when installed in the second orientation as shown generally in FIG. 28.

FIG. 33 is a right side perspective view showing a sunshade according to a ninth embodiment installed on a golf cart.

FIG. 34 is an opposite perspective view of the sunshade shown generally in FIG. 33.

FIG. 35 is an enlarged partial perspective view showing details of structure of a sunshade according to an eleventh embodiment installed on a golf cart.

### DETAILED DESCRIPTION OF THE INVENTION

In the following detailed description, reference is made to the accompanying drawings that form a part hereof, and in which are shown by way of illustration specific embodiments which may be practiced. These embodiments are described in sufficient detail to enable those skilled in the art to practice the embodiments. It is to be understood that other embodiments may be utilized and that logical, mechanical, electrical and other changes may be made without departing from the scope of the embodiments. The following detailed description is, therefore, not to be taken in a limiting sense.

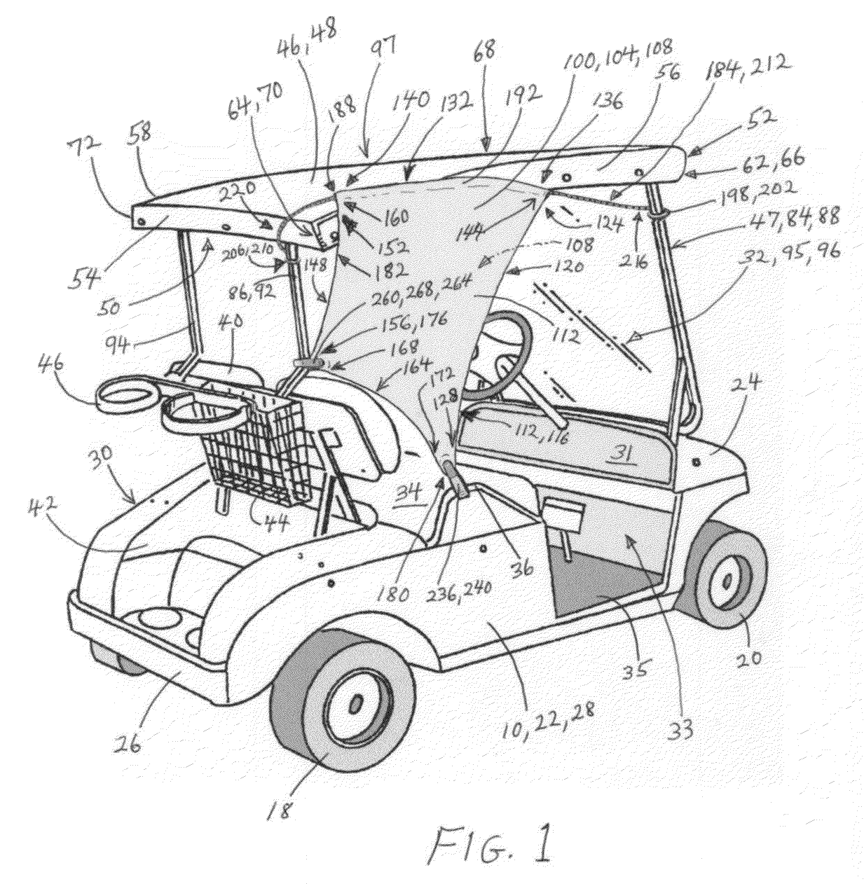

FIG. 1 is a right side perspective view showing a sunshade 100 according to a first embodiment installed on a golf cart 10. Golf cart 10 is of ordinary construction, which will be described for reference. It will be understood that the term “golf cart”, as used herein, refers also to golf cars and golf buggies, and can also include any passenger cart of similar size and construction, but lacking a golf bag well, which can be used to transport people in environments other than around golf courses. For example, as used herein, “golf cart” includes utility carts, turf carts, and hospitality carts having an open passenger compartment, such as carts which are used to transport personnel around grounds of large facilities such as, for example, resorts and manufacturing facilities. and on farms and ranches. Manufacturers of golf carts as herein described include, but are not limited to, Club Car (Augusta, Ga.), EZ-Go (Augusta, Ga.), Yamaha Golf Car Company (Newnan, Ga.), FairPlay Cars (Grand Junction, Colo., and Jacobsen (Charlotte, N.C.).

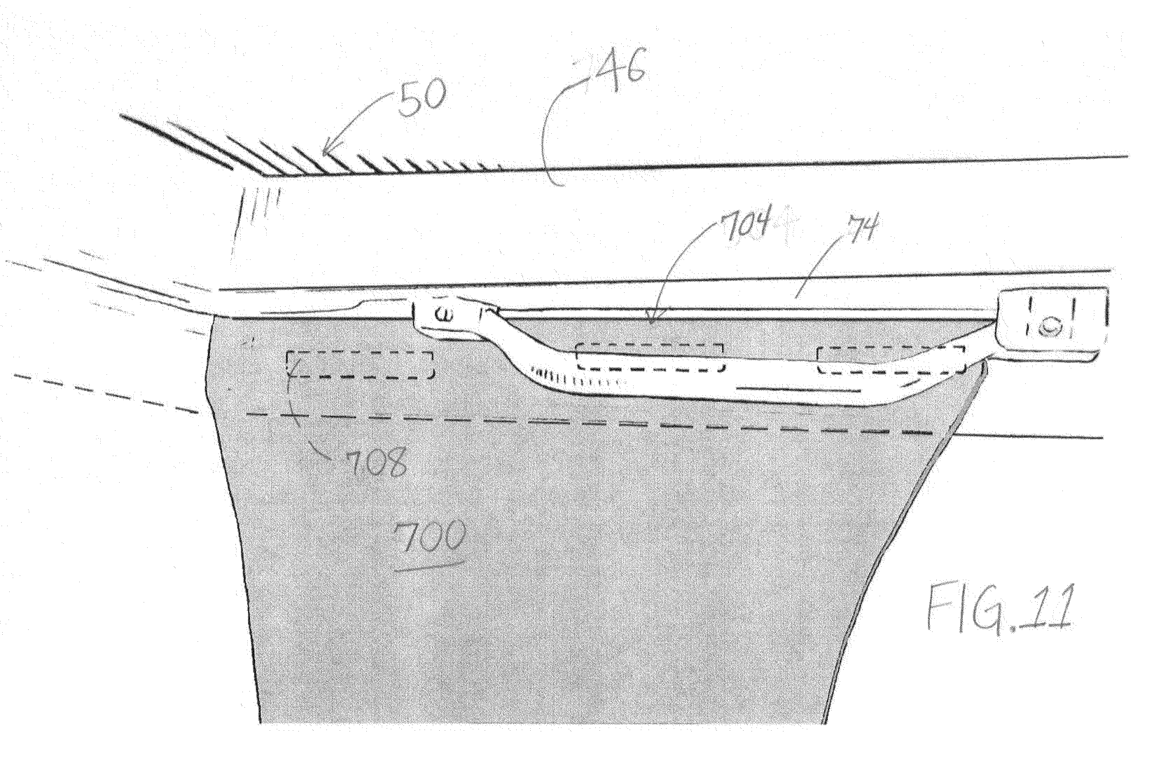

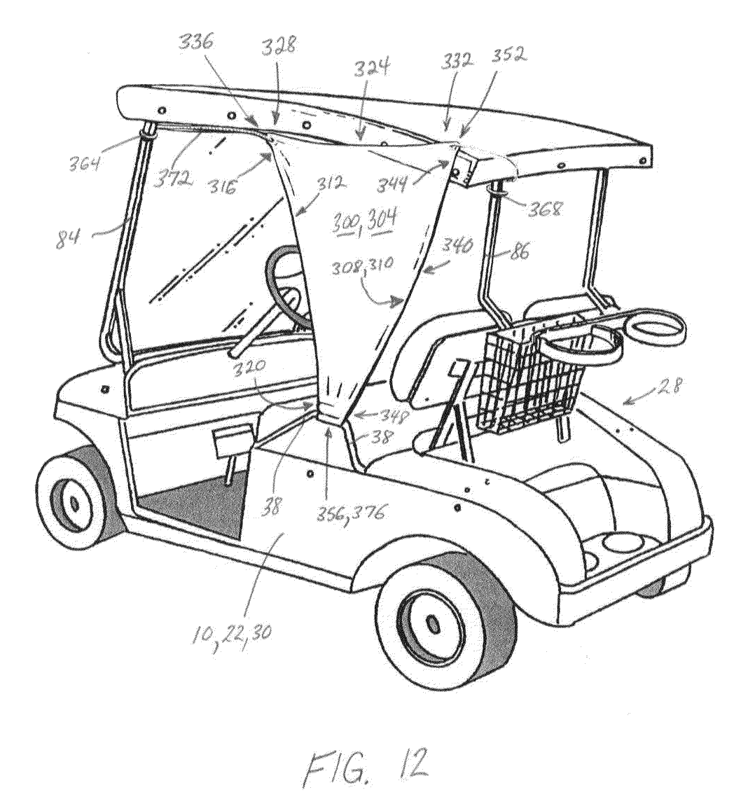

Golf cart 10 includes a pair of rear wheels 18 mounted on a rear axle (not shown) and a pair of steerable front wheels 20 mounted along a common front wheel axis (not shown). Golf cart 10 is propelled by operation of a suitable electric motor or small internal combustion engine (not shown). Golf cart 10 includes a cart body 22. Cart body 22 is supported by the wheels (18, 20) for travel across ground. The cart body 22 has a front 24 adjacent the front wheels 20 and a rear 26 adjacent the rear wheels 18. Cart body 22 has a first side 28 and an opposite second side 30 extending between the front 24 and rear 26. Cart body 22 defines a passenger compartment 32 intermediate the front wheels 20 and rear wheels 18. Passenger compartment 32 is open. Passenger compartment 32 includes a front dash 31 and a floor 35. In the specific embodiment illustrated in FIG. 1, it will be understood that a transparent windscreen and steering column extend upward from front dash 31. Cooperation of front dash 31 and floor 35 defines an open leg well 33 in front of a suitable seat 34. Passenger compartment 32 includes the seat 34, which is sized to comfortably accommodate two adults seated side-by-side and facing in the forward direction. Seat 34 extends across passenger compartment 32 and has a first end at first side 28 and a second end at second side 30. Seat 34 has a seat bottom 37 and a generally vertical seat back 40. In the specific arrangement illustrated, seat bottom 37 and seat back 40 are formed separately. Seat back 40 is supported in a fixed position to cooperate with seat bottom 37 to support the seated passengers. In other arrangements (not shown), seat back 40 can be formed or molded in integral relationship with seat bottom 37. Cart body 22 includes a first seat arm rail 36 supported above the first end of seat 34 at first side 28 and a second seat arm rail 38 (see FIG. 12) supported above the second end of seat 34 at second side 30. Cart body 22 lacks passenger doors on both the right side 28 and left side 30, so that passengers can step from the ground onto floor 35 of passenger compartment 32 and be seated on seat 34 with legs in leg well 33, or vice-versa, without operating a passenger door. Cart body 22 includes a golf bag well 42 located at the rear 26 and behind bench seat back 40. Golf bag well 42 is open and sized to accommodate a pair of upright golf bags (not shown) carrying golf clubs (not shown). Golf cart 10 includes a golf bag bracket 46 supported in a fixed location above golf bag well 42 to secure the pair of golf bags (not shown) in a fixed, upright position. Golf cart 10 includes an equipment basket 44 supported in a fixed location between bench seat back 40 and golf bag bracket 46. Golf cart 10 includes a cart roof 46 which is supported in spaced relationship above cart body 22 to cover passenger compartment 32. Golf cart 10 includes a set of posts 47 which support cart roof 46 above cart body 22.

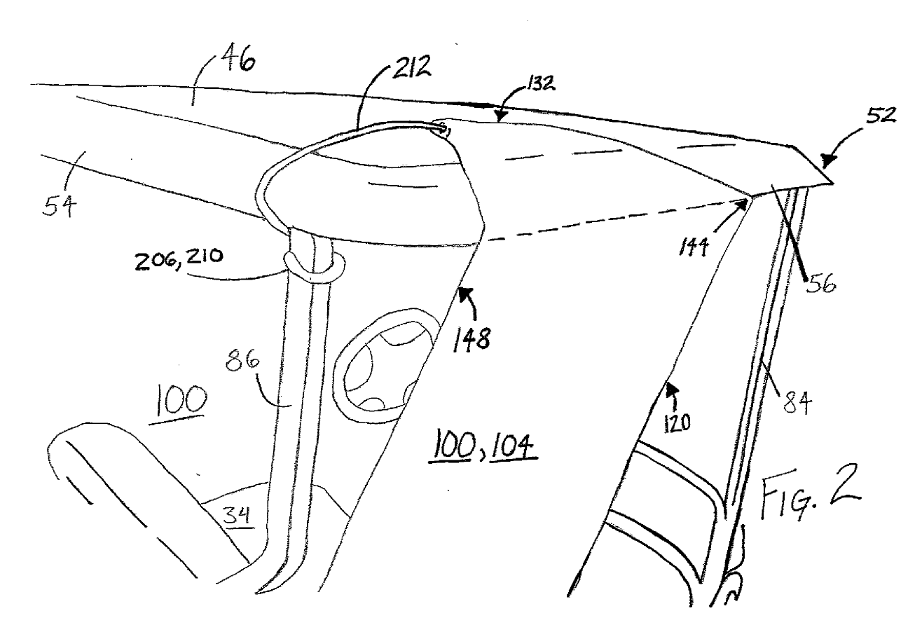

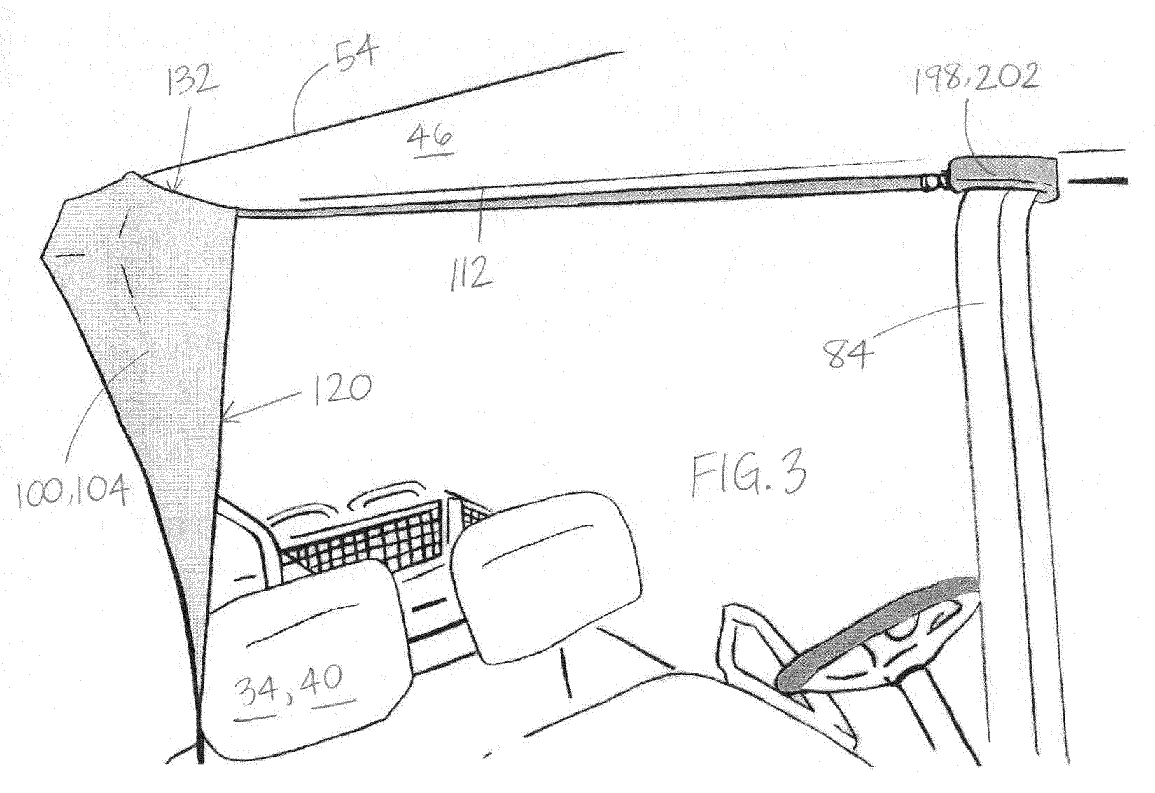

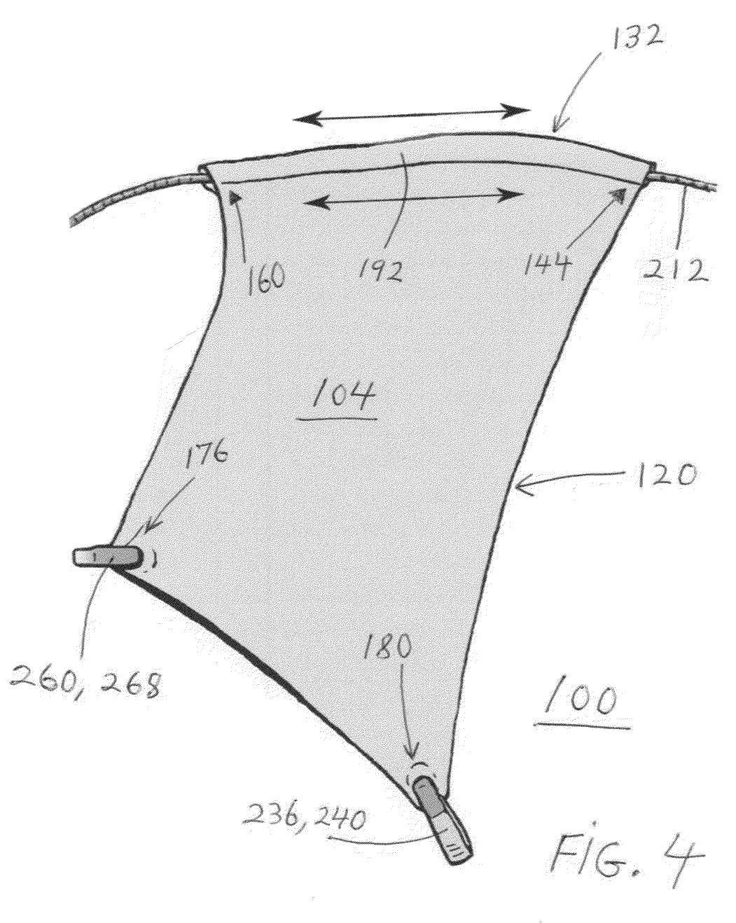

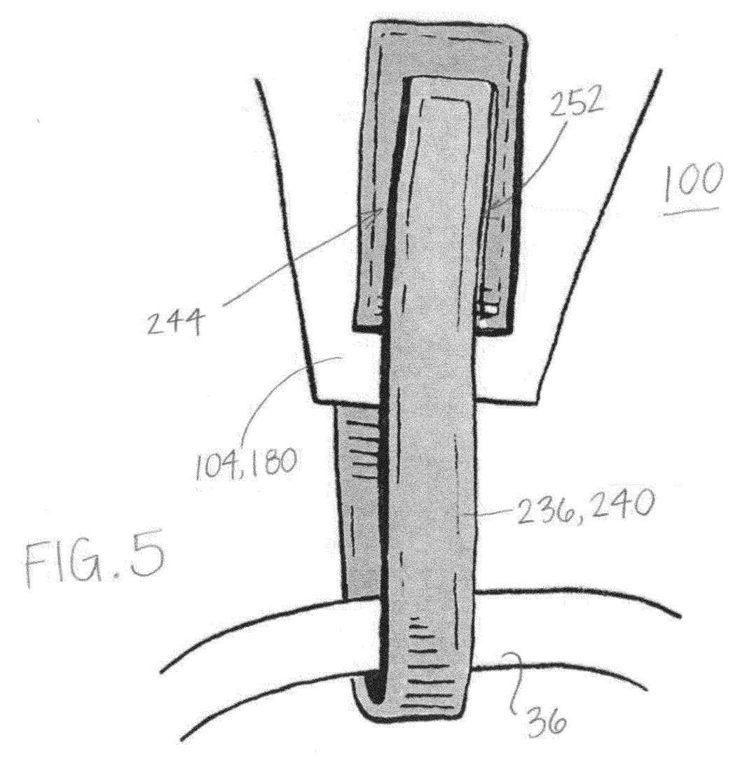

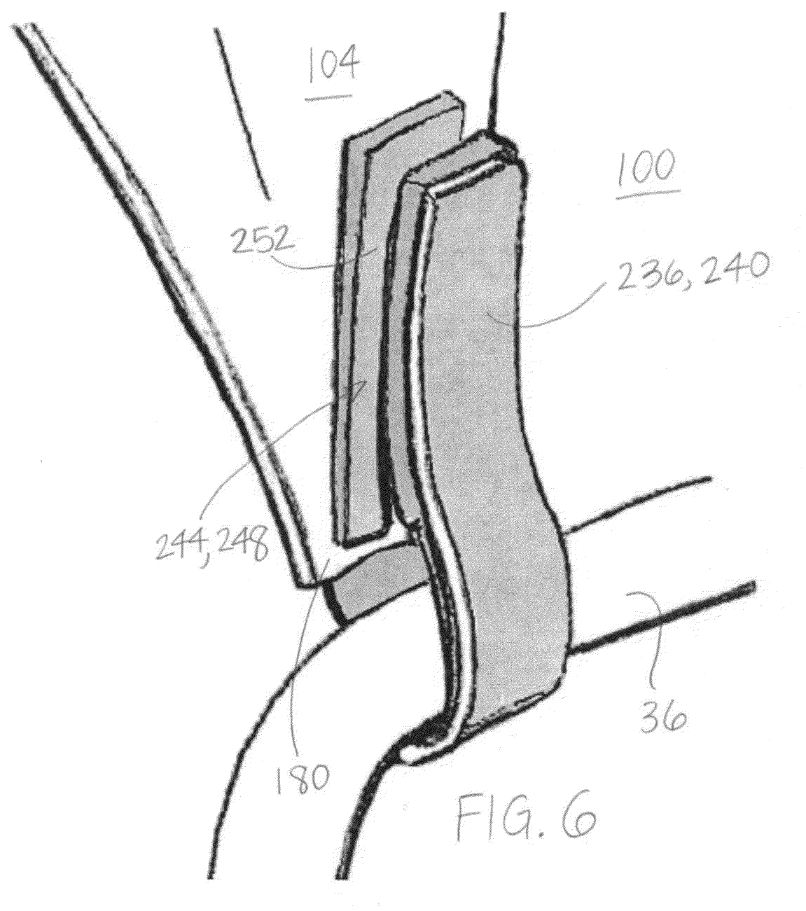

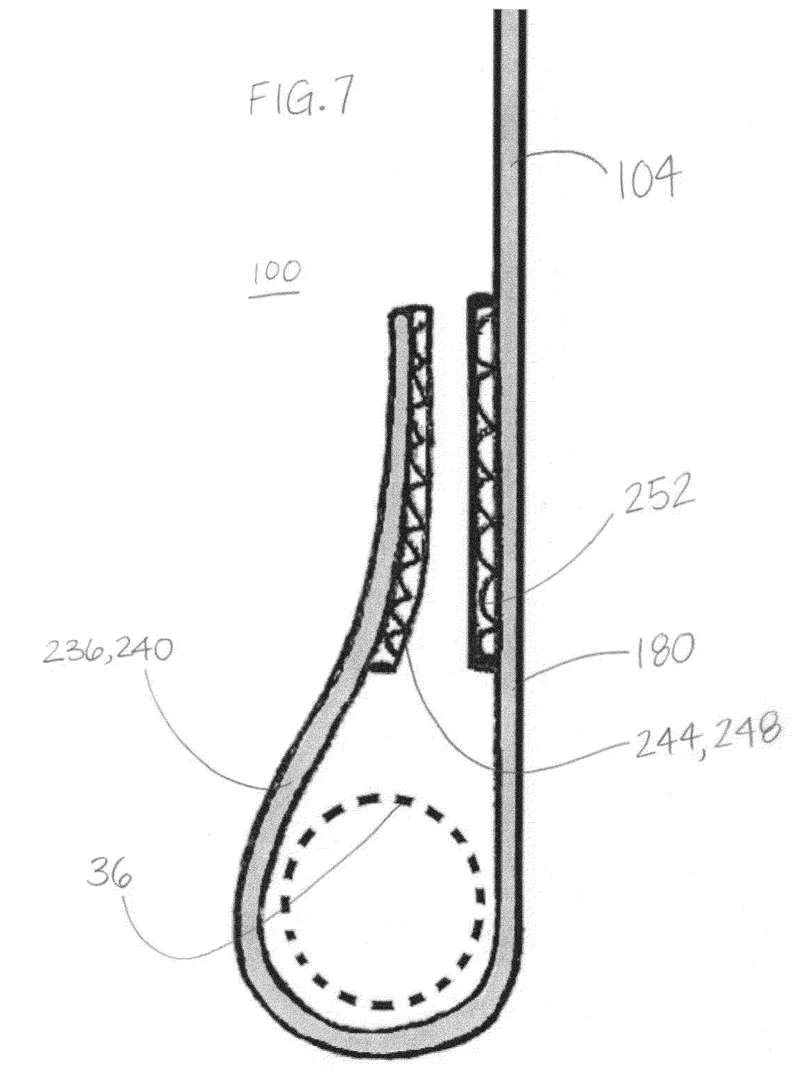

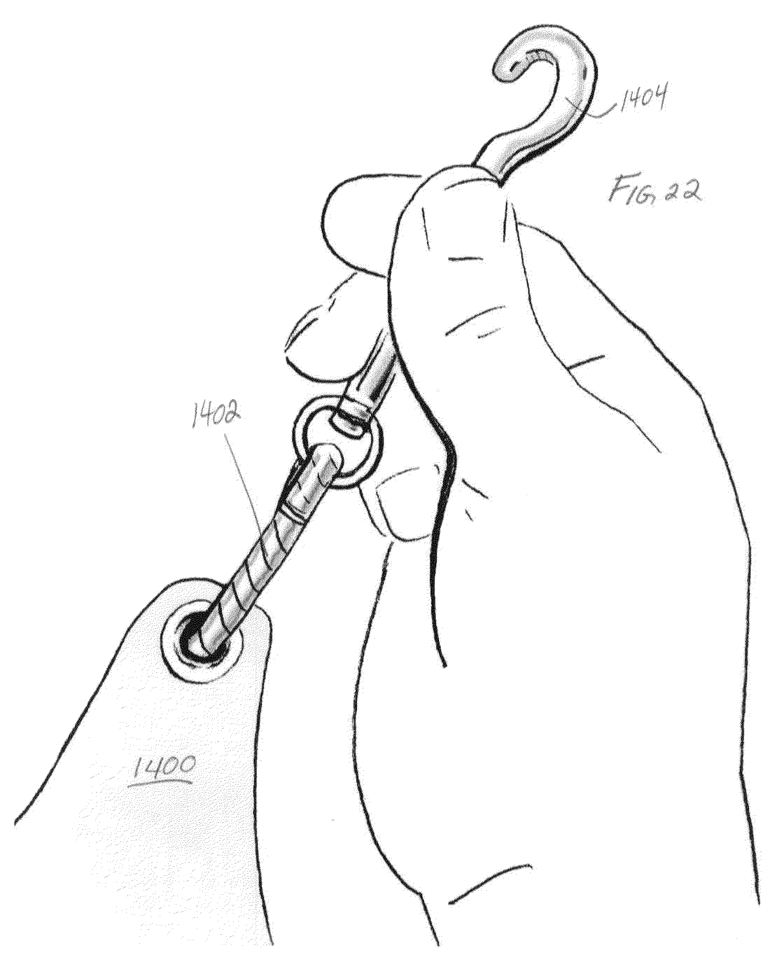

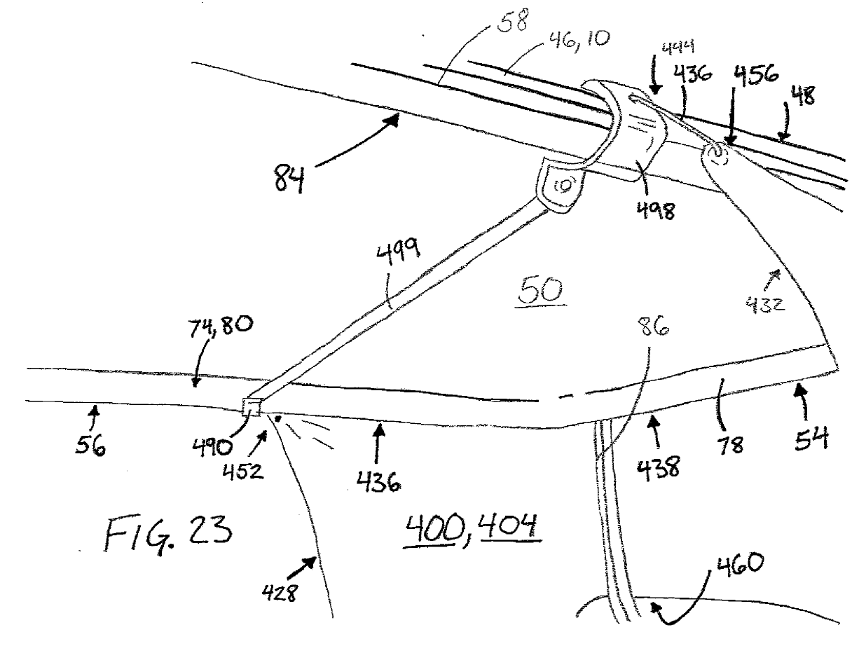

Cart roof 46 will be further described. Cart roof 46 is a generally flat or planar member having a roof top surface 48 and an opposed roof bottom surface 50. Cart roof 46, when viewed from above, has a substantially rectangular perimeter shape that includes a roof front edge 52 and a roof rear edge 54. When viewed from above (see FIG. 2), roof front edge 52 is spaced generally above and slightly forward of front dash 31. Roof rear edge 54 is spaced generally above and behind bench seat back 40. When viewed from above (see FIG. 2), roof rear edge 54 terminates at a location intermediate bench seat back 40 and golf bag bracket 46, in order to provide cover above the seated passengers and also permit access for golf clubs (not shown) to be removed and replaced in the golf bags (not shown). It will be appreciated that golf clubs are typically inserted into and removed from golf bags by being inserted and removed lengthwise through the top of the golf bag, such that extending the cart roof above golf bag well 42 can constrain vertical clearance and inhibit players from readily removing and replacing golf clubs (not shown) lengthwise through the top of the upright golf bags (not shown) located in golf bag well 42. Cart roof 46 includes a first roof major edge 56 and an opposite second roof major edge 58, each extending between roof front edge 52 and roof rear edge 54 in generally perpendicular relationship thereto. In the specific embodiment illustrated in FIG. 1, first roof major edge 56 is located at right, and second roof major edge 58 is located at left. In the specific arrangement illustrated, first roof major edge 56 is spaced outwardly from and above respective first side 28 and thus overhangs the same by several inches, and second roof major edge 58 is spaced outwardly from and above respective second side 30 and thus overhangs the same by several inches. It will be appreciated that cart roof 46 is a substantially planar member which is generally rectangular in shape when viewed from above, and thus has a pair of roof front corners 62 and a pair of roof rear corners 64. The pair of roof front corners 62 includes a first roof front corner 66 spaced from an opposed second roof front corner 68. It will be appreciated that roof front edge 52 extends between first roof front corner 66 and second roof front corner 68. The pair of roof rear corners 64 includes a first roof rear corner 70 and an opposed second roof rear corner 72. It will be appreciated that roof rear edge 54 extends between first roof rear corner 70 and second roof rear corner 72. It will also be appreciated that first roof major edge 56 extends between first roof front corner 66 and first roof rear corner 70. Likewise, it will be appreciated that second roof major edge 58 extends between second roof front corner 68 and second roof rear corner 72, in parallel opposed relationship to first roof major edge 56. In the specific embodiment illustrated, it will be appreciated that continuous roof lip 74 (see FIG. 23) extends around the perimeter of cart roof 46. Referring to FIG. 23, roof lip 74 thus includes segments which are identified as follows: roof front edge lip (not shown) extending along roof front edge 52, roof rear edge lip 78 extending along roof rear edge 54, roof first edge lip 80 extending along first roof major edge 56, and roof second edge lip 82 extending along second roof major edge 58. It will be appreciated that, in other arrangements (not shown), roof lip 74 can be configured differently and can be discontinuous. It will be understood that roof lip 74 can be of any suitable cross-sectional shape or profile. In the specific embodiment illustrated in FIG. 1, roof lip 74 has a generally “J-shaped” cross-sectional profile (see FIG. 23) and tapers downwardly from roof top surface 48 (at the top of the “J”) to a position (at the bottom of the “J”) which is spaced below roof bottom surface 50, and then curves upwardly and joins roof bottom surface 50 (at the lower terminal end of the “J”).

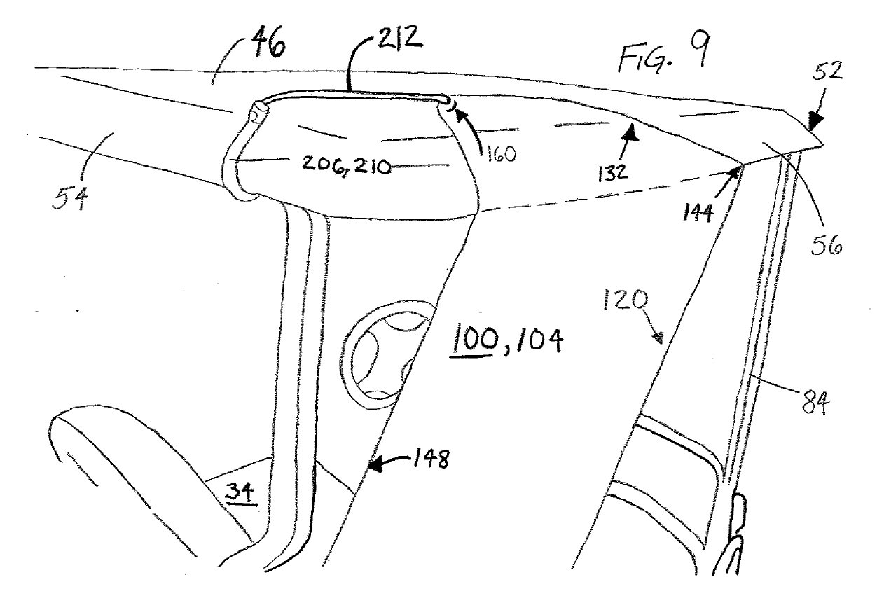

Referring to FIG. 1, the set of posts 47 which support cart roof 46 above cart body 22 will be described in further detail. It will be understood that golf cart 10 can include any set of posts 47 which is suitable to support cart roof 46 above cart body 22. In the specific embodiment illustrated, the set of posts 47 includes four (4) spaced posts 47. More particularly, in the specific embodiment illustrated, the set of four (4) posts 47 includes a pair of front corner posts 84 and a pair of rear corner posts 86. The pair of front corner posts 84 includes a first front corner post 88 and a second front corner post 90. First front corner post 88 is spaced inwardly by several inches from first roof front corner 66 along roof front edge 52 and intersects roof bottom surface 50 inside roof front edge lip 76. Second front corner post 90 (see FIG. 10) is spaced inwardly by several inches from second roof front corner 68 along roof front edge 52 and intersects roof bottom surface 50 inside roof front edge lip 76. Referring to FIG. 1, the pair of roof rear corner posts 86 includes a first rear corner post 92 and a second rear corner post 94. The first rear corner post 92 is spaced inwardly by several inches from first roof rear corner 70 along roof rear edge 54 and intersects roof bottom surface 50 inside roof rear edge lip 78. The second rear corner post 94 is spaced inwardly by several inches from second roof rear corner 72 along roof rear edge 54 and intersects roof bottom surface 50 inside roof rear edge lip 78. Cart roof 46 is affixed to the posts 48 in a suitable manner, such as with bolts. Each of the posts 48 is formed of suitable structural material. In the specific embodiment illustrated, posts 48 are formed of metal tube having a square cross-sectional profile and a nominal width of about two inches (2″).

Referring again to FIG. 1, it will be understood that golf cart 10 has a pair of passenger side openings 95. The pair of passenger side openings 95 include first passenger side opening 96 and second passenger side opening 97. First passenger side opening 96 is disposed to permit passenger ingress from the ground into passenger compartment 32 along first side 28 of cart body 22. Second passenger side opening 97 is disposed to permit passenger ingress from the ground into passenger compartment 32 along second side 30 of cart body 22. First passenger side opening 96 is defined between first roof major edge 56 and first side 28 of cart body 22 intermediate first rear corner post 94 and first front corner post 88. Second passenger side opening 97 is defined between second roof major edge 56 and second side 30 of cart body 22 intermediate second rear corner post 94 and second front corner post 90. First passenger side opening 96 and second passenger side opening 97 are open and permit sunlight incident therein to enter passenger compartment 32.

Shown in FIG. 1 is an embodiment which is a sunshade 100 for use with golf cart 10. Sunshade 100 is portable and is suitable to be temporarily affixed to a golf cart 10. Sunshade 100 can be temporarily installed on different golf carts 10 which a passenger may use on different days and at different golf courses. Sunshade 100 is lightweight and can be readily folded for storage. Sunshade 100 can be stored between uses in a compartment of a golf bag (not shown) and carried from location to location for use with different golf carts 10 to reduce sunlight entering the passenger compartment during use of the golf cart 10. It will be understood that, when sunshade 100 is used in rain, sunshade 100 deflects rain away from the passenger compartment and seat.

Sunshade 100 includes flexible fabric member 104. Fabric member 104 is configured to be temporarily affixed to a golf cart 10. Fabric member 104 can be formed of any suitable material which prevents a portion of sunlight from entering passenger compartment 32. In the embodiment illustrated in FIG. 1, fabric material 104 transmits less than about 50 percent of incident sunlight. It will be understood that transmission of more or less than 50% of incident sunlight is possible according to embodiments, and depends upon the selected fabric material 104. In the embodiment illustrated in FIG. 1, fabric material is a flexible open mesh material 108 having a large number of openings to allow air flow through sunshade 100. In the embodiment illustrated in FIG. 1, open mesh material 108 include a plurality of intersecting web members (not shown) arranged in an open mesh pattern. In the specific embodiment shown in FIG. 1, the web members are of small diameter to improve visibility through open mesh material 108. It will be understood that open mesh material 108 can be selected to provide a desired degree of transparency and visibility from the passenger compartment through open mesh material 108. It will be understood that open mesh material 108 can be selected to provide a desired degree of impermeability to rain and to maintain dry conditions in the passenger compartment when exposed to rain. Open mesh material 108 includes a plurality of interstitial web openings (not shown) defined between the intersecting web members. A suitable commercially available embodiment of fabric material 104 which is open mesh material 108 is the Phifer Super Solar Series of sun control fabric products, which is manufactured by Phifer Incorporated of Tuscaloosa, Ala. Another suitable commercially available embodiment of fabric material 104 which is open mesh material 108 is the Phifer Suntech Series of sun control fabric products, which is manufactured by Phifer Incorporated of Tuscaloosa, Ala. It will be understood by those of ordinary skill that where the fabric material 104 which is open mesh material 108 according to the preceding specific commercially available embodiments, incident sunlight entering the passenger compartment through the use fabric material 104 can be reduced by about 90% while providing acceptable visibility enabling safe use of a golf cart. It will be understood that further improved commercially available fabric materials 104, such as future versions of open mesh material 108, are expected to become available in the future, and that such materials can be used in construction of a sunshade as herein described. Fabric member 104 has an inner surface 108 facing passenger compartment 32. Fabric member 104 has an outer surface 112 disposed in opposition to inner surface 108. Fabric member 104 has an outer perimeter 112 defined by cooperation of a plurality of intersecting edges 116. Fabric member 104 has a continuous major forward edge 120. Major forward edge 120 has a major forward upper end 124 spaced above a major forward lower end 128. Fabric member 104 has a continuous upper edge 132. Upper edge 132 has an upper edge forward end 136 spaced from an upper edge rear end 140. Major forward upper end 124 intersects upper edge forward end 136 at an upper forward corner 144 formed between the same. Fabric member 104 has a continuous minor rear edge 148 spaced apart from the major forward edge 120. Minor rear edge 148 has a minor rear upper end 152 which is spaced from a minor rear lower end 156. Upper edge rear end 140 intersects minor rear upper end 152 at an upper rear corner 160 formed between the same. Fabric member 104 has a continuous lower edge 164 spaced apart from upper edge 132. Lower edge 164 has a lower edge rear end 168 spaced from a lower edge forward end 172. Lower edge rear end 168 intersects minor rear lower end 156 at a lower rear corner 176 formed between the same. Lower edge forward end 172 intersects major forward lower end 128 at a lower forward corner 180 formed between the same. In the specific embodiment illustrated in FIG. 1, at least one of the major forward edge 120, upper edge 132, minor rear edge 148, and lower edge 164 includes at least one curvilinear segment. According to embodiments (not shown), any or all of the edges can be straight or substantially straight. Particularly, in the specific embodiment illustrated in FIG. 1, major forward edge 120, minor rear edge 148, and lower edge 164 each include curvilinear segments 182, and upper edge 132 is straight. It will be understood that curvilinear segments 182, in the illustrated embodiments, are concave and thus are readily drawn taut to reduce flapping motion of the same. Curvilinear segments 182 are contoured to be placed under tension when sunshade 100 is installed on golf cart 10. Curvilinear segments 182 being placed under tension when installed stabilizes respective edges 116 when in an installed condition. As used herein, the term “installed condition” references, at least, when sunshade 100 is installed by each fastener thereof being secured to golf cart 22 in the position described and illustrated to place a tension load on each corner of fabric member 104. Curvilinear segments 182 are also contoured to create open space for air flow into passenger compartment 32 around outer perimeter 112 while also reducing entry of sunlight into passenger compartment 32 when sunshade 100 is installed on golf cart 10. It will be understood that, according to embodiments, any edge such as, for example, major forward edge 120, upper edge 132, minor rear edge 148, and lower edge 164 can be straight or curvilinear, or can include both straight and curvilinear segments. For example, any curved edges or edges having curvilinear segments can include generally concave sections or segments which function to provide a taut edge and avoid excessive flapping in wind passing the cart.

It will be understood that fabric member 140 can have any suitable dimensions. In the specific embodiment illustrated in FIG. 1, fabric member 140 when laid flat in an uninstalled condition has approximate dimensions as follows: major forward edge 120 has a length of about 26 inches to about 36 inches; upper edge 132 has a length of about 20 inches to about 30 inches; minor rear edge 148 has a length of about 20 inches to about 30 inches; and lower edge 164 has a length of about 16 inches to about 26 inches. Also, in the specific embodiment illustrated in FIG. 1, upper forward corner 144 has an included angle of about 45 degrees to about 75 degrees; upper rear corner 160 has an included angle of about 75 degrees to about 100 degrees; lower rear corner 176 has an included angle of about 60 degrees to about 90 degrees; and lower forward corner 180 has an included angle of about 45 degrees to about 75 degrees. In the specific embodiment illustrated in FIG. 1, lower rear corner 176 is spaced apart from major forward edge 120 by at least about 15 inches; lower forward corner 180 is spaced from upper rear corner 160 by at least about 28 inches; and upper forward corner 144 is spaced from lower rear corner 176 by at least about 26 inches.

Upper forward corner 144 is joined to an upper mounting cord 184 intermediate roof front edge 52 and upper rear corner 160. Upper rear corner 160 is joined to upper mounting cord 184 intermediate upper forward corner 144 and roof rear edge 54. In the embodiment illustrated in FIG. 1, fabric member 104 includes capture structure 188. Capture structure 188 is located at upper edge 132 and joins fabric member 104 with upper mounting cord 184. In the specific embodiment illustrated in FIG. 1, capture structure 188 includes a fabric sleeve 192. Fabric sleeve 192 is formed by the fabric material 104 being doubled back on it self and sewn at upper edge 132 to create a tubular opening or sleeve. Fabric sleeve 192 captures upper mounting cord 184 and permits sliding movement of fabric member 104 along upper mounting cord 184 for selectively positioning upper edge 132 relative to cart roof 32 along a path defined by upper mounting cord 184. In an alternate embodiment (not shown), capture structure 188 can include, for example, a set of eyelets, grommets, cord clips, or sections of plastic tubing fixed to fabric member 104. Eyelets capture upper mounting cord 184 and permit sliding movement of said fabric member 104 along upper mounting cord 184.

Sunshade 100 includes an upper forward fastener 198. Upper forward fastener 198 is manually positioned at one of roof front edge 52 and a front corner post 84. Upper forward fastener 198 is configured for releasable fastening engagement with one of roof front edge 52 and front corner post 84. In the embodiment illustrated in FIG. 1, upper forward fastener 198 includes a forward “J” hook fitting 202. J-hook fitting 202 is configured for releasable engagement, in the alternative, with all of the following: roof front edge 52, upper mounting cord 184, and front corner post 84. It will be understood that upper forward fastener 198 can be any fastener configured for releasable fastening engagement with roof front edge 52, upper mounting cord 184, and front corner post 84. Examples of suitable fasteners include, but are not limited to, flexible straps including mating hook and loop fastening materials, “C” hook fittings, flexible straps including mating snap fasteners, clips, clamps, spring clips, pressure clips, spring clamps, pressure clamps, and brackets. It will be understood that the aforementioned can be directly affixed to fabric member 104 in a suitable manner such as, for example, by being joined by a plurality of stitches.

Sunshade 100 includes an upper rear fastener 206. Upper rear fastener 206 is manually positioned at one of roof rear edge 54 and a rear corner post 86. Upper rear fastener 206 is configured for releasable fastening engagement with one of roof rear edge 54 and rear corner post 86. In the embodiment illustrated in FIG. 1, upper rear fastener 206 includes a rear “J” hook fitting 210. Rear J-hook fitting 210 is configured for releasable engagement, in the alternative, with all of the following: roof rear edge 54, upper mounting cord 184, and rear corner post 86. It will be understood that upper forward fastener 198 can be any fastener configured for releasable fastening engagement with roof rear edge 54, upper mounting cord 184, and rear corner post 86. Examples of suitable fasteners include, but are not limited to, flexible straps including mating hook and loop fastening materials, “C” hook fittings, flexible straps including mating snap fasteners, clips, clamps, spring clips, pressure clips, spring clamps, pressure clamps, and brackets. It will be understood that the aforementioned can be directly affixed to fabric member 104 in a suitable manner such as, for example, by being joined by a plurality of stitches.

Sunshade 100 includes elongated flexible upper mounting cord 212. Upper mounting cord 212 has a mounting cord forward end 216. Upper mounting cord 212 has a mounting cord rear end 220. Mounting cord rear end 220 is spaced apart from mounting cord forward end 216 in opposed relation to same. Mounting cord forward end 216 is joined to upper forward fastener 198. Mounting cord rear end 220 is joined to upper rear fastener 206. Upper mounting cord 212 has an effective length between upper forward fastener 198 and upper rear fastener 206 which is sufficiently short to impart tension in upper mounting cord 212 when upper forward fastener 198 is fastened to one of roof front edge 52 and front corner post 84 and when at the same time upper rear fastener 206 to one of roof rear edge 54 and rear corner post 86, such that tension draws upper mounting cord 212 snug against cart roof 46. It will be understood that a range of tension loads are suitable to draw upper mounting cord 212 against cart roof 46. Upper mounting cord 212 can be formed of any suitable flexible material 220. In the specific embodiment illustrated in FIG. 1, upper mounting cord 212 is formed of flexible material 220 which is flexible elastic bungee cord material 220. Examples of suitable flexible material 220 includes, but are not limited to, elastic straps, non-elastic straps, cord, and any suitable cinching members. According to an embodiment (not shown), for example, upper mounting cord 212 is trained around cart roof 46 between roof front edge 52 and roof rear edge 54, and is joined together by an adjustable buckle fitting in an elongated loop.

In sunshade 100, upper forward corner 144 is joined to upper mounting cord 212 intermediate roof front edge 52 and upper rear corner 160. Upper rear corner 160 is joined to upper mounting cord 212 intermediate upper forward corner 144 and the roof rear edge 54. More particularly, in the specific embodiment illustrated in FIG. 1, fabric sleeve 192 captures upper mounting cord 212 and permits sliding movement of fabric member 104 at upper edge 132 along upper mounting cord 212 for selectively positioning upper edge 132 relative to cart roof 46 along a path defined by upper mounting cord 212 drawn against cart roof 46, such that upper forward corner 144 is joined to upper mounting cord 212 intermediate roof front edge 52 and upper rear corner 160, and such that upper rear corner 160 is joined to upper mounting cord 212 intermediate upper forward corner 144 and the roof rear edge 54. It will be understood that upper edge 132 can be manually positioned along the path defined by upper mounting cord 184 drawn against cart roof 46 by sliding fabric sleeve 192 relative to upper mounting cord 184. According to embodiments (not shown), a pair of positionable keepers, such as a pair of rubber rings tightly encircling the upper mounting cord 212, can be provided to prevent fabric sleeve 192 from slipping away from a selected location along upper mounting cord 184 According to an embodiment (not shown in FIG. 1), upper mounting cord 212 includes a discrete mounting cord forward segment 228 and a discrete mounting cord rear segment 232 spaced from same. Mounting cord forward segment 228 includes mounting cord forward end 216. Mounting cord forward segment 228 is joined to fabric material 104 in spaced relationship to upper forward fastener 198. Mounting cord rear segment 232 includes mounting cord rear end 220. Mounting cord rear segment 232 is joined to fabric material 104 in spaced relationship to upper rear fastener 206.

Sunshade 100 includes lower forward fastener 236. Lower forward fastener 236 is configured for releasable engagement with cart body 22. In the specific embodiment illustrated in FIG. 1, lower forward fastener 236 is configured for releasable engagement with a respective first seat arm rail 36 or second seat arm rail 38. Lower forward fastener 236 is joined to lower forward corner 180. Major forward edge 120 is secured in a substantially fixed position when lower forward fastener 236 is fastened to first seat arm rail 36 or second seat arm rail 38 of cart body 22. In the embodiment illustrated in FIG. 1, lower forward fastener 236 includes a flexible flap or extended flexible member 240 joined with fabric member 104. Extended flexible member 240 includes a suitable releasable fastening material 244. In the specific embodiment illustrated in FIG. 1, releasable fastening material 244 includes at least one component of hook and loop fastening material 248. In the embodiment illustrated in FIG. 1, lower forward fastener 236 includes landing area 252 suitable for mating engagement with the component of releasable hook and loop fastening material 248. Landing area 252 is located on one of fabric member 104 and a suitable surface of extended flexible member 240. It will be understood that other suitable releasable fasteners can be used.

Sunshade 100 includes lower rear fastener 260. Lower rear fastener 260 is configured for releasable engagement with rear corner post 86. Lower rear fastener 260 is joined to lower rear corner 176. Minor rear edge 148 is secured in a substantially fixed position when lower rear fastener 260 is fastened to rear corner post 86. In the embodiment illustrated in FIG. 1, lower rear fastener 260 includes a flexible flap or extended flexible member 264 joined with fabric member 104. Extended flexible member 264 includes a suitable releasable fastening material 268. In the specific embodiment illustrated in FIG. 1, releasable fastening material 268 includes at least one component of hook and loop fastening material 272 (not shown). In the embodiment illustrated in FIG. 1, lower rear fastener 260 includes landing area 276 (not shown) suitable for mating engagement with the component of releasable hook and loop fastening material 272. Landing area 276 is located on one of fabric member 104 and a suitable surface of extended flexible member 264. Minor rear edge 148 is secured in a substantially fixed position when lower rear fastener 260 is fastened to rear corner post 86. Lower edge 164 is secured in a substantially fixed position when lower rear fastener 260 is fastened to rear corner post 86. Sunshade 100 prevents a portion of sunlight incident upon outer surface 112 of same from entering passenger compartment 32. It will be understood that other suitable releasable fasteners can be used. Other suitable releasable fasteners can include, but are not limited to, snaps, grommet and hook combinations, cords with hooks, straps with hooks, cords with interlocking t-bar and ring combinations, ties, and straps with suitable buckles.

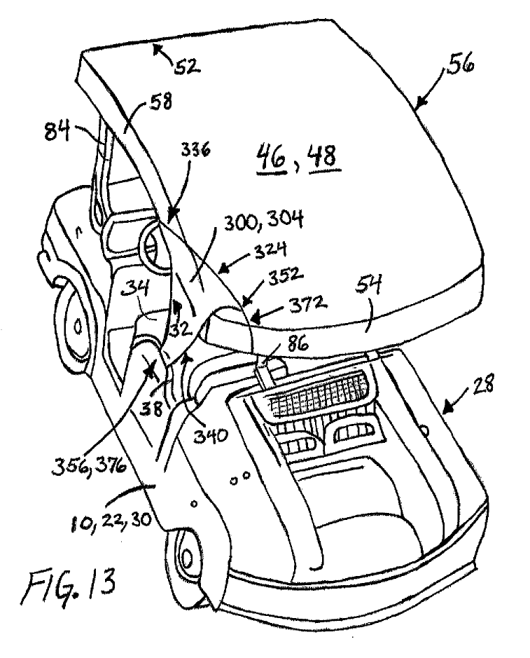

Illustrated in FIG. 12 and FIG. 13 is sunshade 300 according to an embodiment. Except as otherwise described or illustrated, sunshade 300 is similar in construction to sunshade 100 as elsewhere described in this disclosure. Sunshade 300 includes flexible fabric member 304 having outer surface 303. Fabric member 304 has an outer perimeter 308 of generally triangular appearance. Outer perimeter 308 includes a plurality of edges 310. Each edge 310 is of generally curvilinear shape. Fabric member 304 has a continuous major forward edge 312. Major forward edge 312 has a major forward upper end 316 spaced above a major forward lower end 320. Fabric member has a continuous upper edge 324. Upper edge 324 has an upper edge forward end 328 spaced from an upper edge rear end 332. Major forward upper end 316 intersects upper edge forward end 328 at upper forward corner 336 formed between same. Fabric member 304 has a continuous major rear edge 340 spaced apart from major forward edge 312. Major rear edge 340 has a major rear upper end 344 spaced from a major rear lower end 348. Upper edge rear end 332 intersects major rear upper end 344 at an upper rear corner 352 formed between same. Fabric member 304 has a minor lower edge 356 spaced apart from upper edge 324. Minor lower edge 356 is of de minimus length in relation to upper edge 324. Minor lower edge 356 intersects major forward edge 312 and major rear edge 340. Lower edge 356 of de minimus length truncates major forward edge 312 and major rear edge 340 above an imaginary lower corner (not shown), the imaginary lower corner being an imaginary intersection which major forward edge 312 and major rear edge 340 generally approach. Illustrated in FIG. 14 is a related embodiment 380 having minor lower edge 356 omitted, such that major forward edge 312 and major rear edge 340 intersect at a lower corner 382 formed between same.

Referring to FIG. 12, sunshade 300 includes upper forward fastener 364 and upper rear fastener 368. Upper forward fastener 364 is generally identical to upper forward fastener 198 of sunshade 100, as elsewhere described herein. Upper rear fastener 368 is generally identical to upper rear fastener 206 of sunshade 100, as elsewhere described herein. Sunshade 300 includes upper mounting cord 372. Upper mounting cord 372 is generally identical to upper mounting cord 212 of sunshade 100, as elsewhere described herein. Sunshade 300 includes lower fastener 376. Lower fastener 376 is configured for releasable engagement with cart body 22, such as with a first seat arm rail 36 or second seat arm rail 38. Lower fastener 376 is generally identical to lower forward fastener 236 of sunshade 100, as elsewhere described in this disclosure. Lower fastener 376 is joined to minor lower edge 356. In an installed condition, major forward edge 312 is secured in substantially fixed position when lower fastener 376 is fastened to cart body 22. Major rear edge 340 is secured in substantially fixed position when lower fastener 376 is fastened to cart body 22. Sunshade 300 prevents a portion of sunlight incident upon outer surface 303 from entering passenger compartment 32. Illustrated in FIG. 14 is a variation of the embodiment shown in FIG. 12, wherein minor lower edge

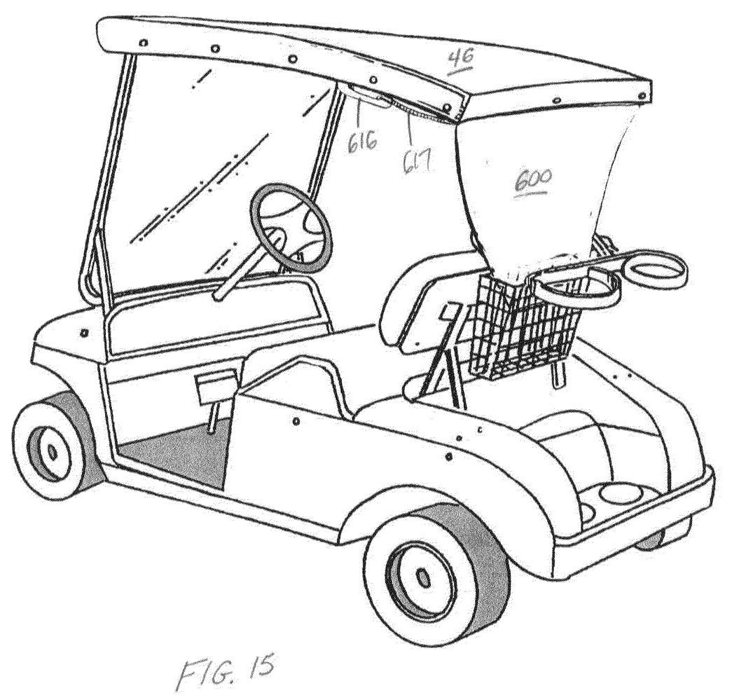

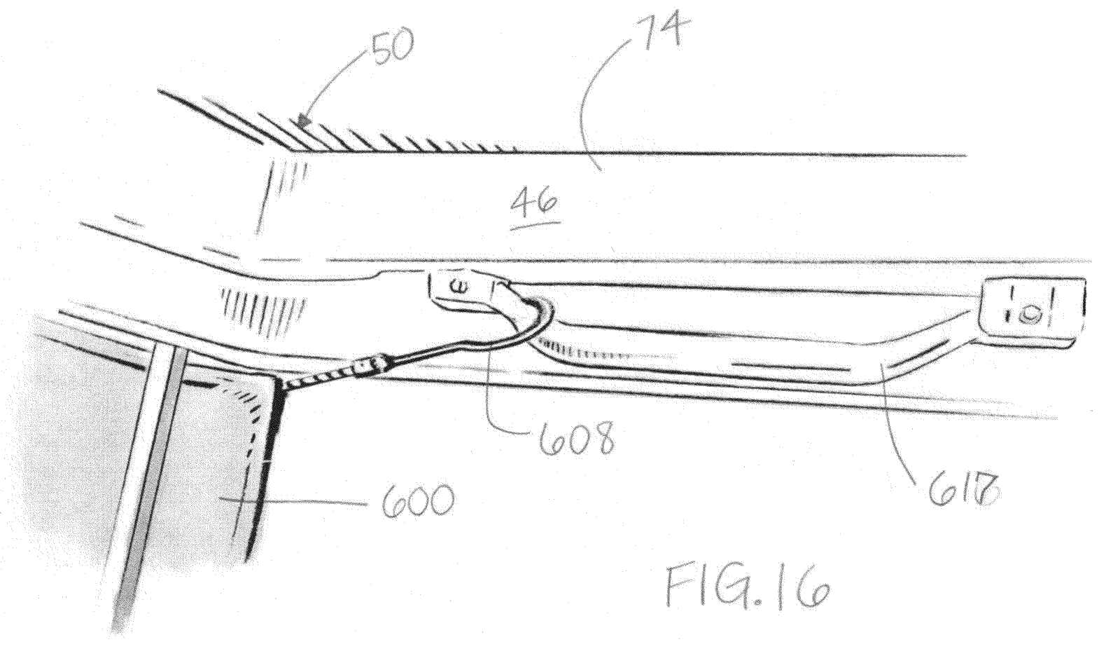

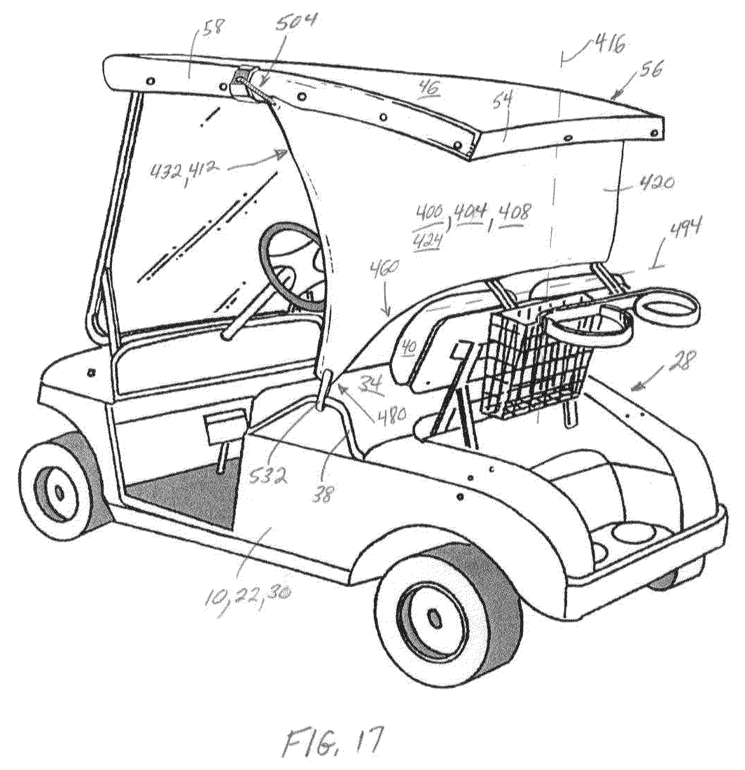

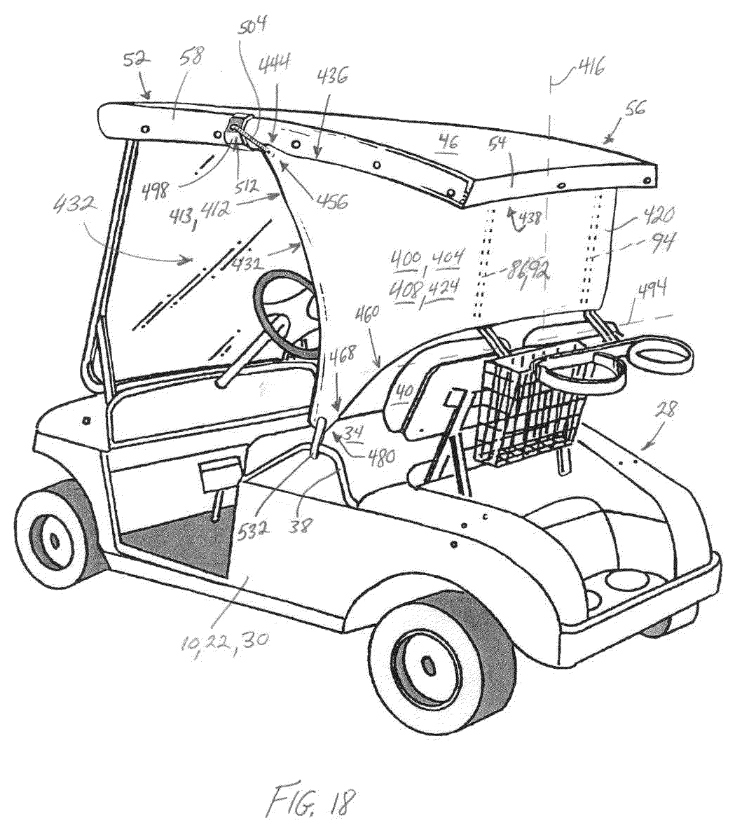

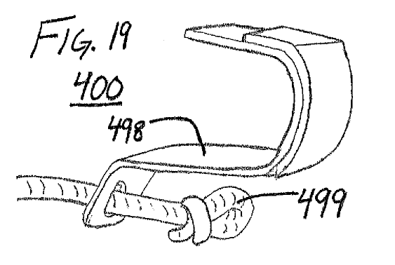

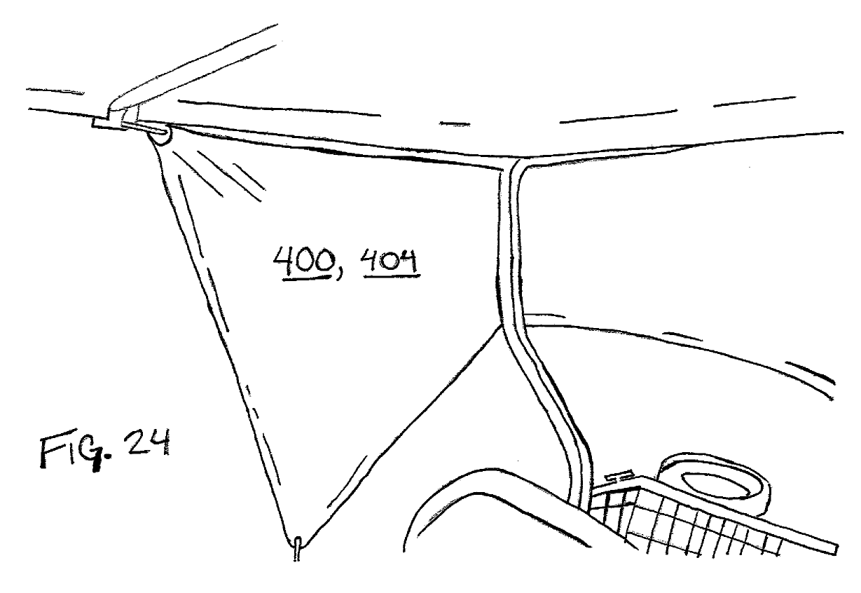

Illustrated in FIG. 17, FIG. 18, FIG. 19, FIG. 20, FIG. 21, FIG. 23, FIG. 24 and FIG. 25 is sunshade 400 according to an embodiment. Except as otherwise described or illustrated, sunshade 400 is similar in construction to sunshade 100, which is described elsewhere in this disclosure. Sunshade 400 includes flexible fabric member 404. Fabric member 404 has an outer surface 408. Fabric member 404 has an outer perimeter 412 defined by cooperation of a plurality of edges 413. Fabric member 404 is configured to wrap around golf cart 10 and thus to shade portions of first side 28, second side 30, and an intermediate rear area located between the pair of rear posts 86. An imaginary vertical centerline 416 can be identified for reference at a midpoint between the pair of rear posts 86. Fabric member 404 has a first half 420 and a second half 424 identified relative to imaginary vertical centerline 416. Second half 424 is a minor image of first half 420. Referring to FIG. 25, fabric member 404 has a continuous first minor forward edge 428. Referring to FIG. 18, fabric member 404 has a continuous second minor forward edge 432. Second minor forward edge 432 is spaced from first minor forward edge 428 (shown in FIG. 25). Returning to FIG. 18, second minor forward edge 432 is located along second side 30 in opposed relationship to first minor forward edge 428 (shown in FIG. 25), first minor forward edge 428 being oppositely located along opposite first side 328. Returning to FIG. 18, it will be understood that second minor forward edge 432 is generally a mirror image of first minor forward edge 328. Fabric member 404 has a continuous major upper edge 436. Major upper edge 436 has a first upper forward end 440 (shown in FIG. 25) spaced from a second upper forward end 444 (shown in FIG. 18). Major upper edge 436 (shown in FIG. 18) has an upper edge midsection intermediate the first upper forward end 440 (shown in FIG. 25) and second upper forward end 444 (shown in FIG. 18). As shown in FIG. 25, first upper forward end 440 intersects first minor forward edge 428 at a first upper corner 452. Second upper forward end 444 intersects second minor forward edge 432 at a second upper corner 456. As shown in FIG. 18, fabric member 404 has a continuous major lower edge 460. Major lower edge 460 is disposed in spaced opposing relationship to major upper edge 436. Major lower edge 460 has a first lower forward end 464 (shown in FIG. 25) spaced from a second lower forward end 468 (shown in FIG. 18). Major lower edge 460 has a lower edge midsection intermediate first lower forward end 464 and second lower forward end 468. As shown in FIG. 25, first lower forward end 464 intersects first minor forward edge 428 at a first lower corner 476. As shown in FIG. 18, second lower forward end 468 intersects second minor forward edge 432 at a second lower corner 480.

Referring to FIG. 25, sunshade 400 includes a first roof bracket 490. First roof bracket 490 is configured for releasable attachment to first roof major edge 56. First roof bracket 490 is selectively positionable along first roof major edge 56 forward of an imaginary reference plane 494. Imaginary vertical reference plane 494 extends through seat back 40 in a direction perpendicular to first roof major edge 56.

Referring to FIG. 18, sunshade 400 includes a second roof bracket 498 configured for releasable attachment to second roof major edge 58. Second roof bracket 498 is selectively positionable along second roof major edge 58 forward of the imaginary vertical reference plane 494 extending through seat back 40. As best seen in FIG. 21, first roof bracket 490 and second roof bracket 498 (not shown in FIG. 21) have a generally “J” shaped profile which cooperates with the roof lip 74.

Referring to FIG. 23 and FIG. 19, sunshade 400 includes flexible second cord 499. Second cord 499 extends beneath bottom surface 50 of cart roof 46 between first roof bracket 490 and second roof bracket 498. Second cord 499 has an effective length which is sufficiently short to impart tension in the second cord 499 in the installed condition. Tension in second cord 499 pulls first roof bracket 490 into secure engagement with first roof major edge 56. Tension in second cord 499 pulls second roof bracket 498 into secure engagement with second roof major edge 58. It will be understood that first and second roof brackets 490,498 can be secured to cart roof 46 in any suitable manner, such as by clamping engagement where clamping force is created by a spring. In the specific embodiment illustrated, second cord 499 is formed of elastic bungee cord material and is permanently affixed (see FIG. 23) to both first and second roof brackets 490,498. In the specific embodiment illustrated, upper mounting cord 436 at second upper forward end 444 is permanently affixed to respective second roof bracket 498. In this manner, sunshade 400 has a unitary construction in which all components are permanently joined or connects together, such that only first fastener 560 connecting upper mounting cord 504 and first roof bracket 490 is releasable from first roof bracket 490 when installing and removing sunshade 400. In the specific embodiment illustrated in FIG. 21, first upper fastener 560 includes a ring 564 which is releasably captured or releasably engages an open, generally “U” shaped mount or harbor fitting 568 formed on first roof bracket 490. It will be understood that, according to embodiments (not shown) sunshade 400 can include a second fastener which is identical to ring 564, or is a hook or hook and loop fastening material such as Velcro, and thus can also be releasable from a compatible second roof bracket located on the opposite side of cart roof 46 from the first roof bracket 490.

Referring to FIG. 18, sunshade 400 includes an elongated flexible upper mounting cord 504. Upper mounting cord 504 is generally identical to upper mounting cord 212 of sunshade 100, except as otherwise described in this section. Upper mounting cord 504 has a first end 508 (see FIG. 21) and a second end 512 (FIG. 18). Second end 512 is spaced from first end 508 in opposing relationship thereto. In an installed condition, upper mounting cord 504 extends between first roof bracket 490 and second roof bracket 498. More particularly, in an installed condition, first end 508 is connected to first roof bracket 490, and second end 512 is connected to second roof bracket 498. In the installed condition, upper mounting cord 504 between first end 508 and second end 512 is routed behind the pair of rear corner posts 86. Upper mounting cord 504 has an effective length which is sufficiently short to impart tension in the upper mounting cord 504 in the installed condition. Tension draws upper mounting cord 504 against the pair of rear corner posts 86. Tension also draws upper mounting cord 504 toward or against cart roof 46.

Referring to FIG. 20, in sunshade 400 first upper corner 452 is joined to upper mounting cord 504 intermediate first end 508 and imaginary vertical reference plane 494. In sunshade 400 a second upper corner 456 is joined to upper mounting cord 504 intermediate second end 512 and imaginary vertical reference plane 494. Sunshade 400 includes a first lower fastener 528 configured for releasable engagement with cart body 22. First lower fastener 528 is joined to first lower corner 476. In installed condition first lower fastener 528 engages cart body 22, such as at first seat arm rail 36. Sunshade 400 includes a second lower fastener 532 configured for releasable engagement with cart body 22, such as at second seat arm rail 38. It will be understood that, in the specific embodiment illustrated, first lower fastener 528 and second lower fastener 532 are identical and flexible strap and a landing area having hook and loop fastening material (not shown), as elsewhere described herein for fastener 236 of the embodiment which is sunshade 100. Second lower fastener 532 is joined to second lower corner 480. In the installed condition first minor forward edge 428 is secured in a substantially fixed position. In the installed condition second minor forward edge 432 is secured in a substantially fixed position. In the installed condition lower edge midsection 472 is drawn against the pair of rear posts 86 by tension exerted on major lower edge 460 by cooperation of first lower fastener 528 and second lower fastener 532. In the installed condition major upper edge midsection 438 is drawn against at least one of the following: the rear posts 86 and the roof rear edge 54. In the installed condition major upper edge 436 is secured in a substantially fixed position. Sunshade 400 prevents a portion of sunlight incident upon the outer surface 408 thereof from entering the passenger compartment 432.

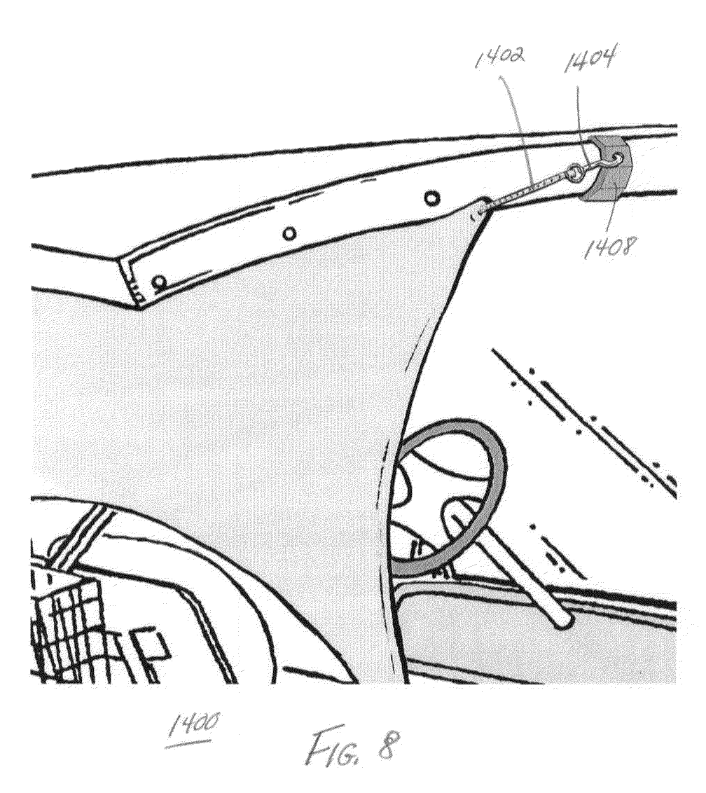

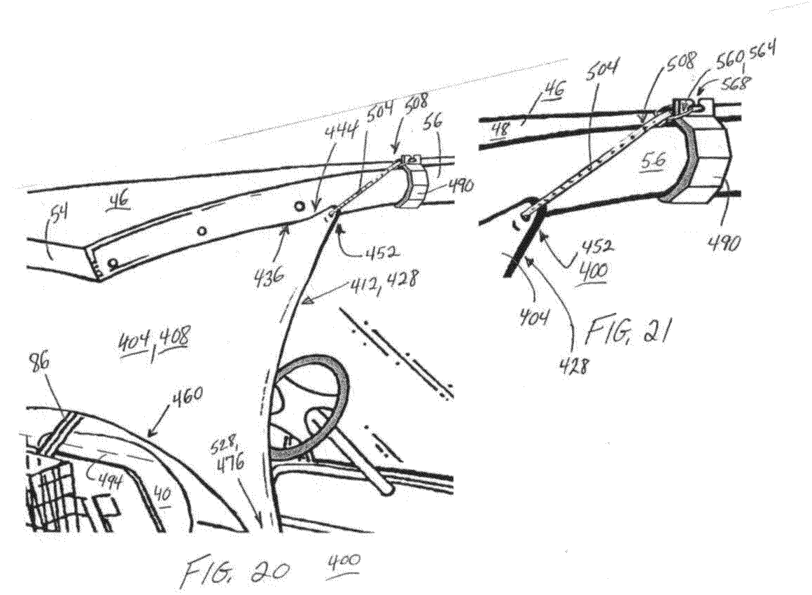

Shown in FIG. 8 and FIG. 22 is a sunshade 1400 according to an embodiment. Sunshade 1400 is identical to sunshade 400 except as otherwise described in this section and illustrated in the drawings. Sunshade 1400 has a hook 1404 permanently affixed to upper mounting cord 1402 and which is suitable for releasable engagement with a first roof bracket 1408 (shown in FIG. 8).

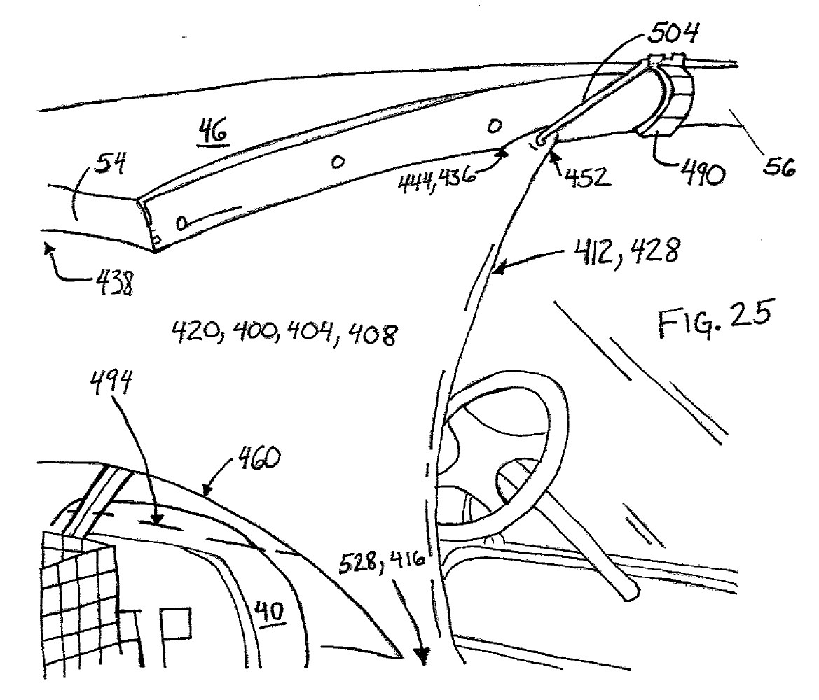

Shown in FIG. 26 is a sunshade 500 according to an embodiment. Sunshade 500 is generally identical to sunshade 400 except as otherwise described in this section and illustrated in the drawings. Sunshade 500 has an upper edge 504. Sunshade 500 at upper edge 504 includes a series of releasable fasteners 508. In the specific embodiment illustrated, releasable fasteners 508 are sections of releasable hook and loop fastener material 508. One component of releasable hook and loop fastener material 508 is permanently joined to upper edge 504, such as by being stitched in place. A mating component of releasable hook and loop fastener material 508 is adhesively secured inside roof lip 74 of cart roof 46. Releasable hook and loop fastener material 508 thus supports upper edge 504 relative to cart roof 46. It will be appreciated that other suitable fasteners can be used. A mating component of releasable hook and loop fastener material 508 is adhesively secured inside roof lip 74 of cart roof 46. It will be appreciated that upper edge 504 can also be secured, in a similar manner, to the respective edge of cart roof 46 outside roof lip 74 instead of inside roof lip 74.

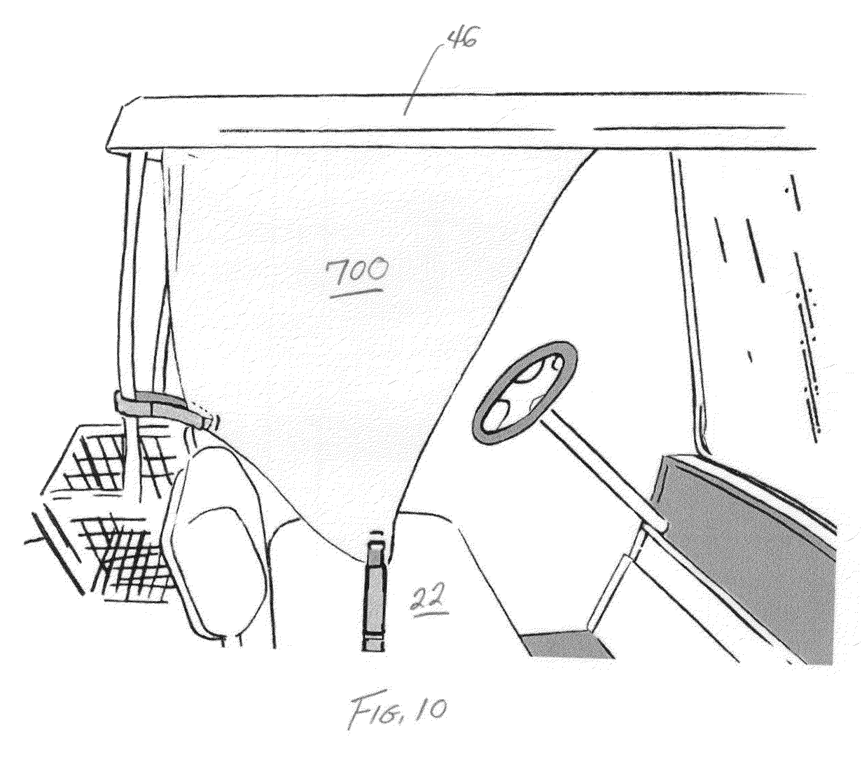

Shown in FIG. 10 and FIG. 11 is an embodiment which is a sunshade 700. It will be understood that FIG. 10 and FIG. 11 illustrate opposite faces of sunshade 700. Sunshade 700 is identical to sunshade 500 except as otherwise described in this section and illustrated in the drawings. Sunshade 700 at upper edge 704 includes a series of releasable fasteners 708. In the specific embodiment illustrated, releasable fasteners 708 are sections of releasable hook and loop fastener material 708. One component of releasable hook and loop fastener material 708 is permanently joined to upper edge 504, such as by stitching. A mating component of releasable hook and loop fastener material 708 is adhesively secured to roof lip 74 of cart roof 46. Releasable hook and loop fastener material 708 thus supports upper edge 704 relative to cart roof 46. It will be appreciated that other suitable fasteners can be used. Sunshade 700 extends only along one side of cart roof 46. It will be understood that sunshade 700 at a lower rear corner includes a releasable fastener, which is the specific embodiment illustrated is a Velcro strap suitable for releasable engagement with a respective one of the rear corner posts.

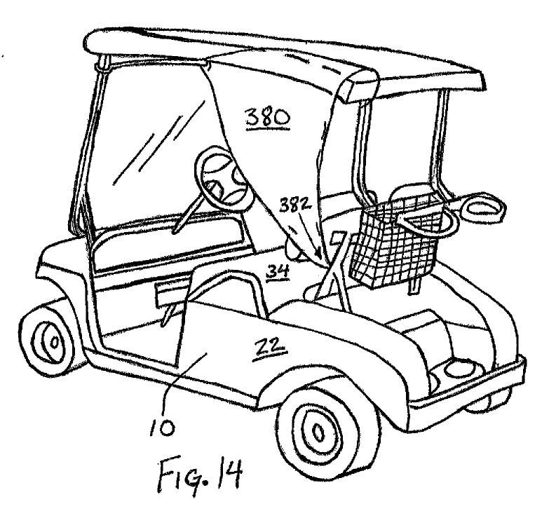

Shown in FIG. 15 and FIG. 16 is a sunshade 600 according to an embodiment. Sunshade 600 is generally identical to sunshade 400 except as otherwise described in this section and illustrated. Sunshade 600 has an upper edge 604. Sunshade 600 at upper edge 604 includes a releasable fastener 608 secured to upper mounting cord 612 and to hand grip bracket 616 of cart roof 46. Sunshade 600 includes an upper mounting cord 617 (see FIG. 16). Although the upper mounting cord 617 in the illustrated embodiment is a bungee cord having a hook at each of the opposite ends thereof, in other embodiments (no shown) the upper mounting cord 617 can be formed of two straps (not shown). Sunshade 600 tapers inwardly from the cart roof 46 toward the cart body 22. It will be understood that sunshade 600 extends only along the rear edge of the cart roof.

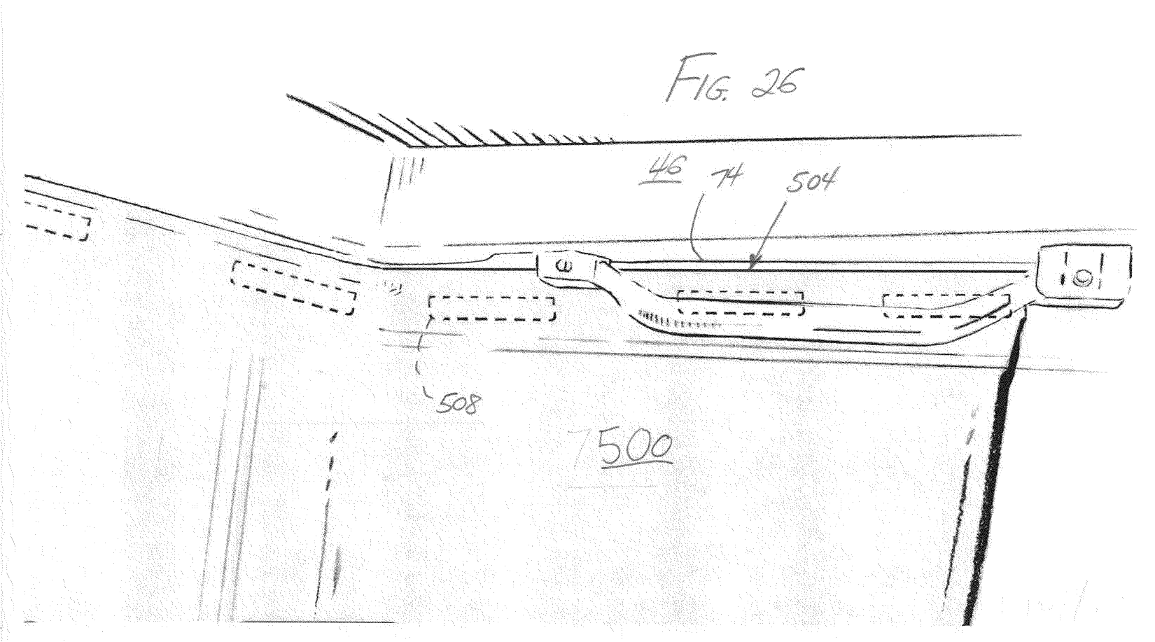

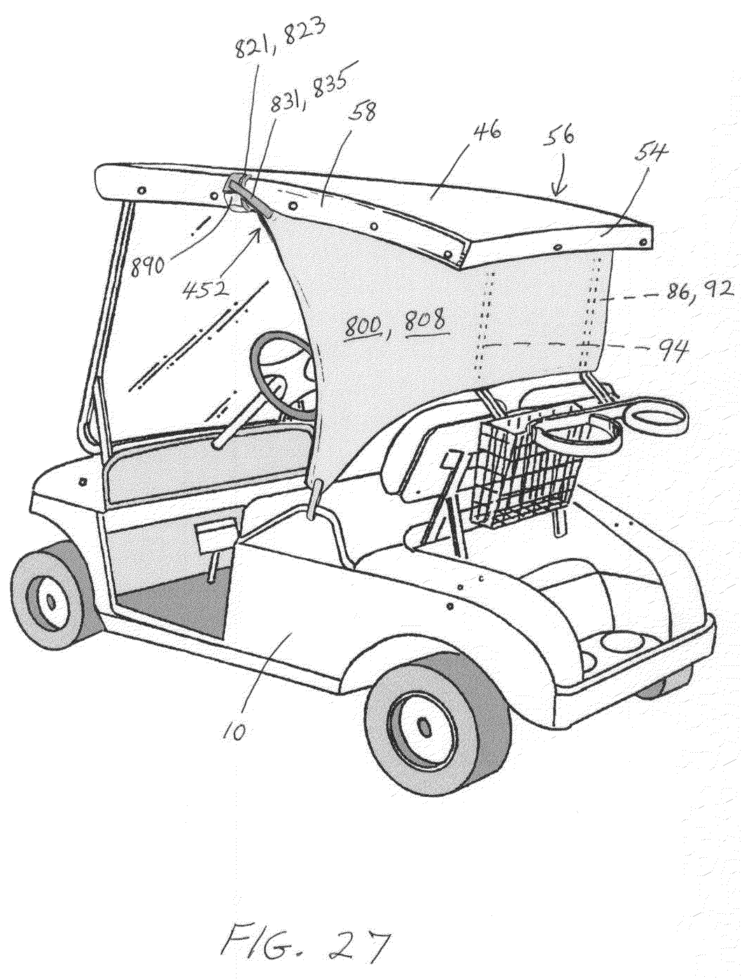

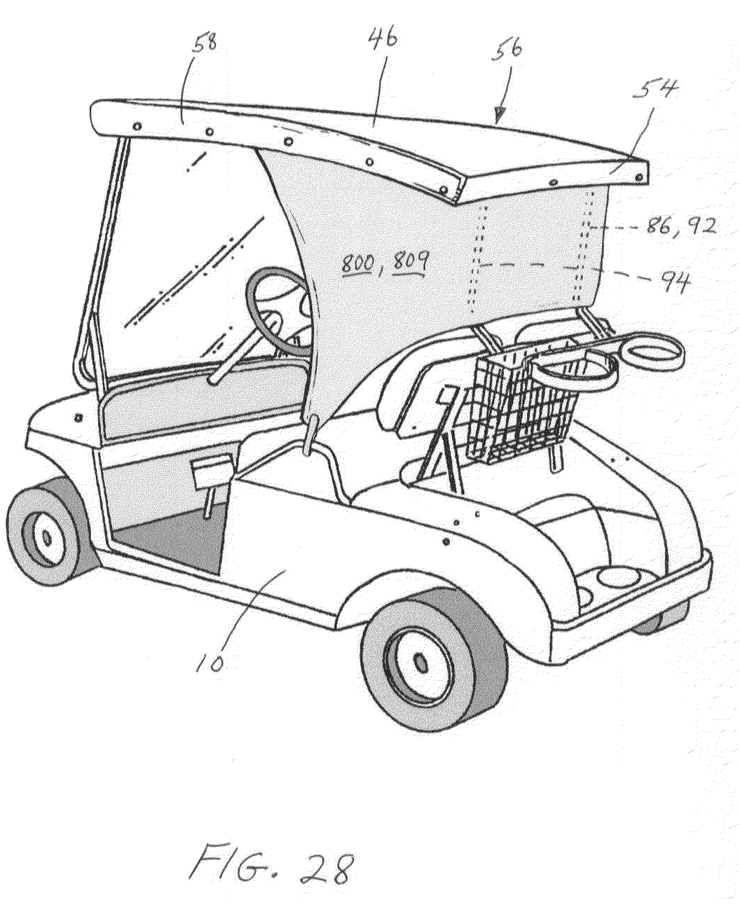

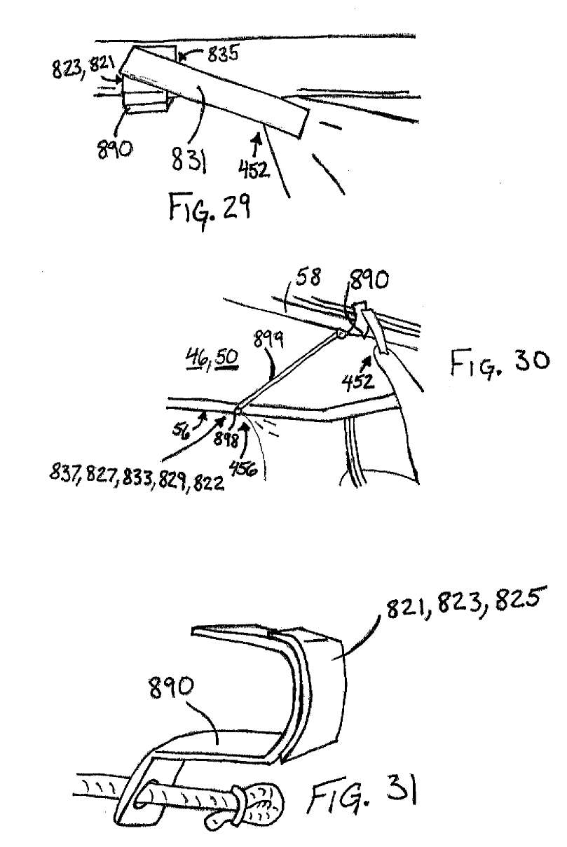

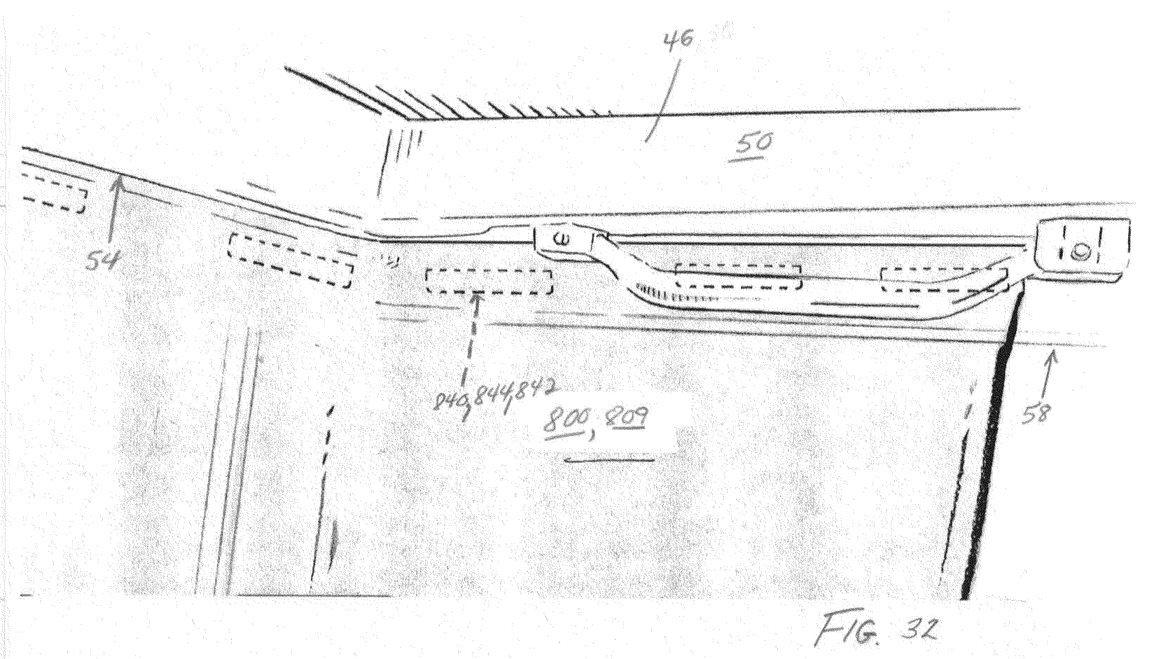

Shown in FIG. 27, FIG. 28, FIG. 29, FIG. 30, FIG. 31 and FIG. 32 is a sunshade 800 according to an eighth embodiment. It will be understood that sunshade 800 according to an eighth embodiment is identical to sunshade 400 according to a fourth embodiment (sunshade 400 being shown generally in FIG. 17), except as otherwise described in this paragraph or except as otherwise illustrated in FIG. 27 through FIG. 32. In view of the preceding statement, all elements, structure and relationships shown in FIG. 17 and in all other figures in reference to sunshade 400, and the written description appearing elsewhere in this specification in reference to sunshade 400, are incorporated by reference, in their entirety, into this paragraph, and thus apply equally to sunshade 800, except as otherwise described in this paragraph or except as otherwise illustrated in FIG. 27 through FIG. 32. FIG. 27 is a left side perspective view showing sunshade 800 installed in a first orientation on a golf cart 10. FIG. 28 is a left side perspective view showing sunshade 800 previously shown in FIG. 27 when installed in a second orientation on a golf cart 10. It will be understood that installation in the first orientation and installation in the second orientation provide a different visual appearance where sunshade 800 approaches cart roof 46, as further described below and as shown in FIGS. 27-32. FIG. 29 is an enlarged partial perspective view showing further details of structure of sunshade 800 as shown generally in FIG. 27. FIG. 30 is an enlarged partial perspective view showing further details of structure of sunshade 800 shown generally in FIG. 29. FIG. 31 is an enlarged partial perspective view showing details of structure of sunshade 800 as shown generally in FIG. 30, before being installed on a golf cart (not shown). FIG. 32 is an enlarged partial interior perspective view taken beneath cart roof 46 and showing details of structure of sunshade 800 when installed in the second orientation shown generally in FIG. 28. Referring to installation in the first orientation as shown in FIG. 27, sunshade 800 includes flexible fabric member 404. Fabric member 404 has an outer surface 408. For purposes of explaining the first orientation shown in FIG. 27 and the second orientation shown in FIG. 28, outer surface 408 is designated also as first major surface 808. It will be understood that sunshade 800 also includes an opposed second major surface 809 facing oppositely from first major surface 808. As shown in FIG. 27, when sunshade 800 is installed in the first orientation shown in FIG. 27, first major surface 808 faces outwardly, and opposed second major surface 809 faces the interior of cart 10. As shown in FIG. 28, when sunshade 800 is installed in the second orientation shown in FIG. 28, second major surface 809 faces outwardly, and opposing first major surface 808 faces the interior of cart 10. In other words, the first major surface 808 and second major surface 809 of sunshade 800 when installed in the second orientation shown in FIG. 28 are flipped around, or turned inside out, from the relative positions occupied when installed in the first orientation shown in FIG. 27. When installed in the first orientation shown in FIG. 27, FIG. 29, FIG. 30, and FIG. 31, a first roof bracket 890 is located opposite from a second roof bracket 898. When in installed in the second orientation shown in FIG. 28 and FIG. 32, it will be understood that first roof bracket 890 and an opposite second roof bracket 898 are optional, and thus are not shown in FIG. 28 and FIG. 32 illustrating installation in the second orientation. Fabric member 404 has an outer perimeter 412 defined by cooperation of a plurality of edges 413. Fabric member 404 is configured to wrap around golf cart 10 and thus to shade portions of first side 28, second side 30, and an intermediate rear area located between the pair of rear posts 86. An imaginary vertical centerline 416 can be identified for reference at a midpoint between the pair of rear posts 86. Fabric member 404 has a first half 420 and a second half 424 identified relative to imaginary vertical centerline 416. Second half 424 is a mirror image of first half 420. Fabric member 404 has a continuous first minor forward edge 428. Fabric member 404 has a continuous second minor forward edge 432. Second minor forward edge 432 is spaced from first minor forward edge 428. Second minor forward edge 432 is located along second side 30 in opposed relationship to first minor forward edge 428, first minor forward edge 428 being oppositely located along first side 328. Second minor forward edge 432 is generally a minor image of first minor forward edge 328. Fabric member 404 has a continuous major upper edge 436. Major upper edge 436 has a first upper forward end 440 spaced from a second upper forward end 444. Major upper edge 436 has an upper edge midsection 448 intermediate the first upper forward end 440 and second upper forward end 444. First upper forward end 440 intersects first minor forward edge 428 at a first upper corner 452. Second upper forward end 444 intersects second minor forward edge 432 at a second upper corner 456. Fabric member 404 has a continuous major lower edge 460. Major lower edge 460 is disposed in spaced opposing relationship to major upper edge 436. Major lower edge 460 has a first lower forward end 464 spaced from a second lower forward end 468. Major lower edge 460 has a lower edge midsection 472 intermediate first lower forward end 464 and second lower forward end 468. First lower forward end 464 intersects first minor forward edge 428 at a first lower corner 476. Second lower forward end 468 intersects second minor forward edge 432 at a second lower corner 480. Referring to FIG. 27, FIG. 29, FIG. 30 and FIG. 31, when installed in the first orientation illustrated therein, sunshade 800 includes first roof bracket 890. First roof bracket 890 is configured for releasable attachment to first roof major edge 56. First roof bracket 890 is selectively positionable along first roof major edge 56 forward of an imaginary reference plane 494. Imaginary vertical reference plane 494 extends through seat back 40 in a direction perpendicular to first roof major edge 56. Referring to FIG. 30, sunshade 800 includes a second roof bracket 898 configured for releasable attachment to second roof major edge 58. Second roof bracket 898 is selectively positionable along second roof major edge 58 forward of the imaginary vertical reference plane 494 extending through seat back 40. As best seen in FIG. 31, first roof bracket 890 and second roof bracket 898 (not shown in FIG. 31) have a generally “J” shaped profile which cooperates with the roof lip 74. Referring to FIG. 30 and FIG. 31, sunshade 800 includes flexible cord 899. Cord 899 extends beneath bottom surface 50 of cart roof 46 between first roof bracket 890 and second roof bracket 898. Cord 899 has an effective length which is sufficiently short to impart tension in the cord 899 in the installed condition. Tension in cord 899 pulls first roof bracket 890 into secure engagement with first roof major edge 56. Tension in cord 899 pulls second roof bracket 898 into secure engagement with second roof major edge 58. It will be understood that first and second roof brackets 890,898 can be secured to cart roof 46 in any suitable manner, such as by clamping engagement where clamping force is created by a spring. In the specific embodiment illustrated, cord 899 is formed of elastic bungee cord material and is permanently affixed (see FIG. 31) to both first and second roof brackets 890,898 in an identical manner. First roof bracket 890 includes a respective first landing area 821. First landing area 821 includes a respective component of hook and loop fastening material 823 which is permanently affixed to or joined with first roof bracket 890, such as by a permanent adhesive layer (not shown). In the specific embodiment illustrated, first landing area 821 includes a barb or hook component 825 of the hook and loop fastening material 823. It will be understood that second landing area 822 includes a barb or hook component 827 of hook and loop fastening material 829 which is permanently affixed to or joined with second roof bracket 898, such as by a permanent adhesive layer (not shown). Sunshade 800 includes a spaced pair of first and second upper mounting straps 831,833. It will be understood that sunshade 800 thus does not include the first upper mounting cord and second upper mounting cord described in reference to sunshade 400. First upper mounting strap 831 is permanently and fixedly joined to flexible fabric member 404 at first upper corner 452. First upper mounting strap 831 includes a respective mating component of the hook and loop fastening material 823. In the specific embodiment illustrated, first upper mounting strap 831 includes a loop component 835 of the hook and loop fastening material 823, such that first upper mounting strap 831 can be temporarily affixed to first landing area 821 on first roof bracket 890. Second upper mounting strap 833 is permanently and fixedly joined to flexible fabric member 404 at second upper forward corner 456. Second upper mounting strap 833 includes a respective mating component of the hook and loop fastening material 829. In the specific embodiment illustrated, second upper mounting strap 833 includes a loop component 837 of the hook and loop fastening material 829, such that second upper mounting strap 833 can be temporarily affixed to second landing area 822 on second roof bracket 898. First upper mounting strap 831 is selectively releasable from first roof bracket 890, and second upper mounting strap 833 is selectively releasable from second roof bracket 898, such that sunshade 800 is readily removable from the same and from cart 10. It will be understood that first roof bracket 890 and second roof bracket 898 are also releasable from roof 46 for installing and removing sunshade 800 on different carts. When installed in the first orientation, first upper mounting strap 831 is affixed to first roof bracket 890 via respective hook and loop fastening material 823, and second upper mounting strap 833 is affixed to second roof bracket 898 via respective hook and loop fastening material 829. In the first orientation, major upper edge 436 and fabric member 404 are routed behind the pair of rear corner posts 86. Cooperation of first upper mounting strap 831 affixed to first roof bracket 890 via respective hook and loop fastening material 823, and second upper mounting strap 833 affixed to second roof bracket 898 via respective hook and loop fastening material 829 imparts tension in the major upper edge 436 when sunshade 800 is installed in the first orientation shown in FIG. 27. Tension draws major upper edge 436 against the pair of rear corner posts 86. Tension also draws major upper edge 436 toward or against cart roof 46. Therefore, if desired, it is possible for sunshade 800 to be supported using only two support points, i.e., first roof bracket 890 and second roof bracket 898. Sunshade 800 includes a first lower fastener 528 configured for releasable engagement with cart body 22. First lower fastener 528 is joined to first lower corner 476. In installed condition first lower fastener 528 engages cart body 22, such as at first seat arm rail 36. Sunshade 800 includes a second lower fastener 532 configured for releasable engagement with cart body 22, such as at second seat arm rail 38. It will be understood that, in the specific embodiment illustrated, first lower fastener 528 and second lower fastener 532 are identical and flexible strap and a landing area having hook and loop fastening material (not shown), as elsewhere described herein for fastener 236 of the embodiment which is sunshade 100. Second lower fastener 532 is joined to second lower corner 480. In the installed condition first minor forward edge 428 is secured in a substantially fixed position. In the installed condition second minor forward edge 432 is secured in a substantially fixed position. In the installed condition lower edge midsection 472 is drawn against the pair of rear posts 86 by tension exerted on major lower edge 460 by cooperation of first lower fastener 528 and second lower fastener 532. When installed in the first orientation shown in FIG. 27, major upper edge midsection 438 is drawn against at least one of the following: the rear posts 86 and the roof rear edge 54. In the installed condition major upper edge 436 is secured in a substantially fixed position. Sunshade 800 prevents a portion of sunlight incident upon the outer surface 408 thereof from entering the passenger compartment 432. Referring now to FIG. 28 and FIG. 32, additional structure of sunshade 800 will be described with reference to installation of sunshade 800 in the second orientation shown in FIG. 28 and FIG. 32. It will be understood that when installed in the second orientation, sunshade 800 along major upper edge 436 is releasably affixed to cart roof 46 by a plurality of spaced, mating first landing areas 840 each consisting of respective hook and loop fastening material 842. More particularly, as best shown in phantom lines in FIG. 32, the plurality of spaced first landing areas 840 each include a respective component of mating hook and look fastening material 842 spaced along major upper edge 436. It will be understood that each first landing area 840 can be permanently affixed to flexible fabric member 404, such as by a permanent adhesive layer (not shown). It will be understood that a plurality of equally spaced but opposed, mating second landing areas 844 are located on cart roof 46 for releasable mating engagement with the plurality of mating first landing areas 840 on sunshade 400. It will be understood that each second landing area 844 can be permanently affixed to cart roof 46, such as by a permanent adhesive layer (not shown). As shown in phantom lines in FIG. 32, in the specific embodiment illustrated, the plurality of second landing areas 844 are located the underside of cart roof 46 along respective of first edge 58, second edge 56 and rear edge 54. It will be understood that cooperation of the plurality of first and second landing areas 840,844 support major upper edge 436 at cart roof 46. It can be observed that the overall appearance of cart roof 46 and sunshade 800 is visually appealing.

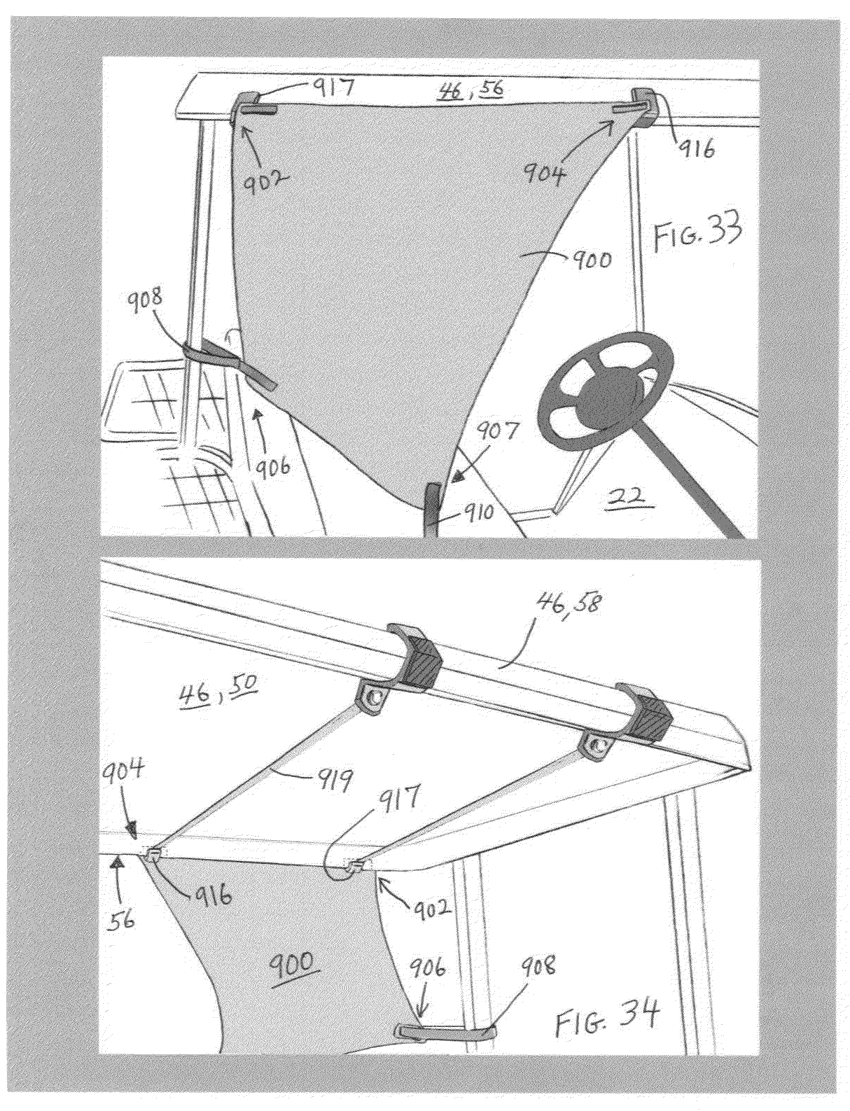

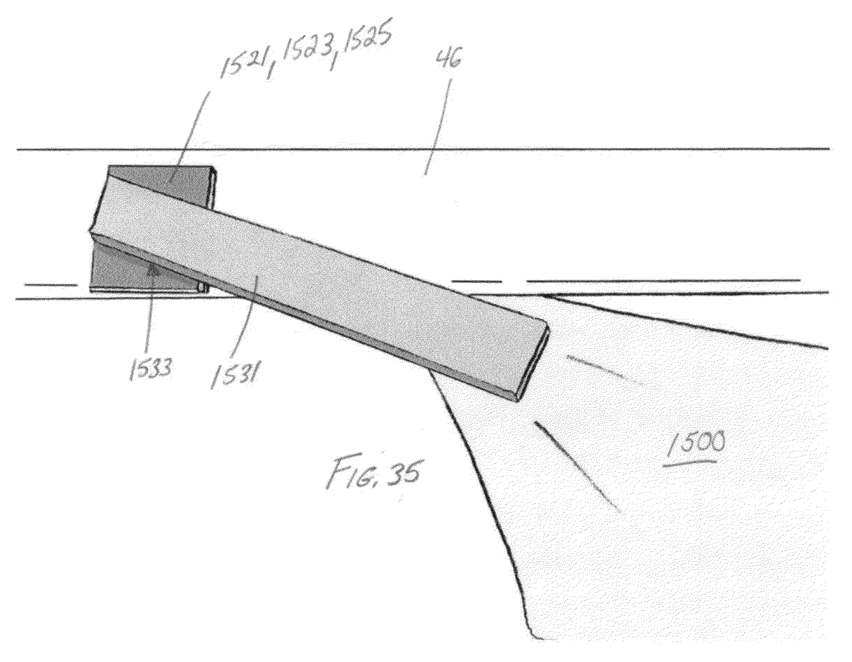

Illustrated in FIG. 33 and FIG. 34 is a sunshade 900 according to an embodiment. FIG. 33 is a right side perspective view showing a sunshade according to a ninth embodiment installed on a golf cart. FIG. 34 is an opposite perspective view of the sunshade shown generally in FIG. 33. It will be understood that sunshade 900 according to a ninth embodiment is identical to sunshade 800 according to an eighth embodiment (sunshade 800 being shown generally in FIG. 27), except as otherwise described in this paragraph or except as otherwise illustrated in FIG. 33 through FIG. 34. In view of the preceding statement, all elements, structure and relationships shown in FIG. 27 and in all other figures in reference to sunshade 800, and the written description appearing elsewhere in this specification in reference to sunshade 800, are incorporated by reference, in their entirety, into this paragraph, and thus apply equally to sunshade 900, except as otherwise described in this paragraph or except as otherwise illustrated in FIG. 33 through FIG. 34. It will be observed that, unlike sunshade 800, sunshade 900 does not wrap around both sides and the rear of cart 10. Sunshade 900 has a rear upper corner 902 which is spaced from a forward upper corner 904. Sunshade 900 has a rear lower corner 906 which is spaced from a forward lower corner 907. The rear lower corner 906 and forward lower corner 907 are releasably affixed to cart body 22 by respective lower rear and forward straps 908 and 910 including mating Velcro landing areas as elsewhere described for embodiments in this specification. Rear upper corner 902 and forward upper corner 904 are releasably affixed to cart roof 46 by respective upper rear strap 912 and upper forward strap 914. Each of upper rear strap 912 and upper forward strap 914 include respective Velcro landing areas which mate for releasable engagement with respective of forward and rear roof brackets 916,917. It will be understood that forward and rear roof brackets 916,917 are identical to first and second roof brackets 890,898 of sunshade 800 and are held in place under tension imparted by a respective bungee cord 919. Bungee cord 919 functions in the same manner as bungee cord or flexible cord 899 of sunshade 800. Forward and rear roof brackets 916,917 are readily repositionable along the respective edge 56 of cart roof 46 for selectively positioning sunshade 900 to shade a desired portion of the cart interior.

FIG. 35 is an enlarged partial perspective view showing details of structure of a sunshade 1500 according to an eleventh embodiment installed on a golf cart. It will be understood that sunshade 1500 according to an eleventh embodiment is identical to sunshade 800 according to an eighth embodiment, except as otherwise described in this paragraph or except as otherwise illustrated in FIG. 35. In view of the preceding statement, all elements, structure and relationships shown and incorporated by reference in FIG. 27 through FIG. 32 in reference to sunshade 800, and the written description appearing elsewhere in this specification in reference to sunshade 800, are incorporated by reference, in their entirety, into this paragraph, and thus apply equally to sunshade 1500, except as otherwise described in this paragraph or except as otherwise illustrated in FIG. 35. It will be observed that sunshade 1500 differs from sunshade 800 in that sunshade 1500 does not include a first roof bracket 890 or a second roof bracket 898. Sunshade 1500 includes a respective first landing area 1521 and an identical oppositely located second landing area (not shown). First landing area 1521 includes a respective component of hook and loop fastening material 1523 which is adhesively joined to cart roof 46 by an adhesive layer (not shown). It will be understood that the second landing area (not shown) is identical. It will be understood that the adhesive layer can be a permanent or temporary adhesive layer. In the specific embodiment illustrated, first landing area 1521 includes a barb or hook component 1525 of the hook and loop fastening material 1523. Sunshade 1500 includes a first upper mounting strap 1531 and an oppositely located second upper mounting strap (not shown). First upper mounting strap 1531 includes a respective mating component 1533 of hook and loop fastening material 1523 which is compatible for releasable mating engagement with first landing area 1521. It will be understood that sunshade 1500 thus does not include the first upper mounting cord and second upper mounting cord described in reference to sunshade 400. It will be understood that, if desired, sunshade 1500 can be supported in place using only two points of support, the first and second upper mounting straps in cooperation with the corresponding first and second landing areas, without having any other releasable fasteners spaced along the cart roof and upper edge of the sunshade 1500.

Embodiments provide a sunshade which is conveniently portable for transport and use by a golfer on different golf carts during different rounds of golf. Embodiments provide a sunshade which can be quickly folded or rolled up and stored in a compartment of a golf bag or similar storage compartment. Embodiments provide a sunshade which can be quickly and easily installed by a single person after being assigned a golf cart but before teeing off to play a round of golf. Embodiments provide a sunshade which prevents a substantial portion of incident sunlight from entering a shaded portion of the passenger compartment of a golf cart. Embodiments provide a sunshade which is of limited size when installed to permit air flow around the sunshade into the passenger compartment. Embodiments provide a sunshade which can be positioned and repositioned by golfers during use of a golf cart in relation to conditions, such as the position of the sun and the extent of intervening cloud cover. Embodiments provide a sunshade which can be formed of open mesh material to permit substantial air flow through the sunshade. Embodiments provide a sunshade which can have edges drawn taut or tight to reduce flapping and to enhance the appearance of the sunshade and golf cart. Embodiments provide a sunshade which has a forward edge that is selectively positionable to permit ready access by a passenger for entering and exiting the passenger compartment. Embodiments provide a sunshade which can be constructed in which all components are joined together in a unitary device to simplify storage, retrieval from storage and repeated temporary installations on different golf carts in different locations. Embodiments provide a sunshade which can have, if desired, windows or cutouts.

Embodiments which are sunshades are described. Although specific embodiments are illustrated and described herein, it will be appreciated by those of ordinary skill in the art that any arrangement which is calculated to achieve the same purpose can be substituted for the specific embodiments shown. This application is intended to cover any adaptations or variations. Those of ordinary skill in the art will appreciate that other terminology can be used to describe subject matter in this application. It is expected that terminology used herein will not be considered as limiting the scope of embodiments. It will be understood that implementations falling within the scope of embodiments can be made using any suitable materials and constructions, and can be described using suitable terminology other than the specific terminology set forth in this application. In particular, one of skill in the art will readily appreciate that the names of the methods and apparatus are not intended to limit embodiments. Furthermore, additional methods and apparatus can be added to the components, and functions can be rearranged among the components. New components corresponding to future enhancements and physical devices used in embodiments can be introduced without departing from the scope of embodiments. One of skill in the art will readily recognize that embodiments are applicable to future technologies, such as materials, circuitry and logic, and other components. The terminology used in this application with respect to embodiments is meant to include all structures, constructions, elements, environments, and alternate technologies which provide the same functionality as described herein.

What is claimed is:

1. A sunshade configured for use on a golf cart, the golf cart having a cart body, the cart body having a front, the cart body having a rear spaced from the front in opposite relationship thereto, the cart body having a spaced pair of sides disposed in opposed parallel relationship, the sides extending from front to rear in general cooperation therewith, the cart body defining an open passenger compartment intermediate the sides, the golf cart having a cart roof supported above the passenger compartment, the cart roof shading the passenger compartment to prevent sunlight incident thereupon from entering the passenger compartment, the cart roof being a generally planar member disposed in a generally horizontal orientation, the cart roof having a generally rectangular roof periphery, the roof periphery including a pair of opposing spaced front corners, each of the front corners being generally spaced above a respective one of the sides near the front, the roof periphery including a front edge extending between the front corners, the roof periphery including a pair of opposing spaced rear corners, each of the rear corners being generally spaced above a respective one of the sides near the rear, the roof periphery including a rear edge extending between the rear corners, the roof periphery including a pair of roof major edges disposed in spaced parallel relation, each of the roof major edges extending from a front corner generally in perpendicular relation to the front edge to a rear corner generally in perpendicular relation to the rear edge, each of the roof major edges extending in generally parallel relation spaced above a corresponding side of the cart body, the golf cart having a set of roof posts extending upwardly from the cart body to support the cart roof in a fixed position, the roof posts including a pair of front roof posts each disposed near a respective front corner, the roof posts including a pair of rear roof posts each disposed near a respective rear corner, the cart body including a seat located in the passenger compartment, the seat being located forward of the rear roof posts, the seat extending generally between the spaced sides, the seat having a pair of seat ends each disposed near a respective side, the cart body having a seat arm rail supported generally above each of the seat ends, the golf cart having a pair of passenger side openings, each passenger side opening being disposed to permit passenger ingress from the ground into the passenger compartment at a side of the cart body, each of the passenger side openings being defined between a major roof edge and corresponding side of the cart body intermediate a rear roof post and front roof post, each passenger side opening permitting sunlight incident therein to enter the passenger compartment, said sunshade comprising:
a flexible fabric member configured to be temporarily affixed to a golf cart, said flexible fabric member having an inner surface facing the passenger compartment, said flexible fabric member having an outer surface disposed in opposition to said inner surface, said flexible fabric member having an outer perimeter, said flexible fabric member having a continuous major forward edge, said major forward edge having a major forward upper end spaced above a major forward lower end, said flexible fabric member having a continuous upper edge, said upper edge having an upper edge forward end spaced from an upper edge rear end, said major forward upper end intersecting said upper edge forward end at an upper forward corner formed there between, said flexible fabric member having a continuous minor rear edge spaced apart from said major forward edge, said minor rear edge having a minor rear upper end spaced from a minor rear lower end, said upper edge rear end intersecting said minor rear upper end at an upper rear corner formed there between, said flexible fabric member having a continuous lower edge spaced apart from said upper edge, said lower edge having a lower edge rear end spaced from a lower edge forward end, said lower edge rear end intersecting said minor rear lower end at a lower rear corner formed there between, said lower edge forward end intersecting said major forward lower end at a lower forward corner formed there between;
an upper forward fastener manually positioned at one of the cart roof front edge and a front roof post, said upper forward fastener being configured for releasable fastening engagement with the one of the cart roof front edge and the front roof post;
an upper rear fastener manually positioned at one of the cart roof rear edge and a rear roof post, said upper rear fastener being configured for releasable fastening engagement with the one of the cart roof rear edge and the rear roof post;
an elongated flexible upper mounting cord, said upper mounting cord having an upper cord forward end, said upper mounting cord having an upper cord rear end, said upper cord rear end being spaced apart from said upper cord forward end in opposed relation thereto, said upper cord forward end being joined to said upper forward fastener, said upper cord rear end being joined to said upper rear fastener, said upper mounting cord having an effective length between said upper forward fastener and said upper rear fastener which is sufficiently short to impart tension in said upper mounting cord by fastening said upper forward fastener to one of the cart roof front edge and the front roof post and at the same time fastening said upper rear fastener to one of the cart roof rear edge and the rear roof post, the tension drawing said upper mounting cord against the cart roof;
said upper forward corner being joined to said upper mounting cord intermediate the roof front edge and the upper rear corner, said upper rear corner being joined to said upper mounting cord intermediate the upper forward corner and the roof rear edge;
a lower forward fastener configured for releasable engagement with the cart body, said lower forward fastener being joined to said lower forward corner, said major forward edge being secured in a substantially fixed position when said lower forward fastener is fastened to the cart body; and
a lower rear fastener configured for releasable engagement with the rear roof post, said lower rear fastener being joined to said lower rear corner, said minor rear edge being secured in a substantially fixed position when said lower rear fastener is fastened to the rear roof post, said lower edge being secured in a substantially fixed position when said lower rear fastener is fastened to the rear roof post;
whereby said sunshade prevents a portion of sunlight incident upon the outer surface thereof from entering the passenger compartment.

2. A sunshade according to claim 1 and further comprising:
capture structure located at said upper edge, said capture structure joining said fabric member with said upper mounting cord, said capture structure permitting sliding movement of said fabric member along said upper mounting cord for selectively positioning said upper edge relative to said cart roof along a path defined by said upper mounting cord.

3. A sunshade according to claim 2 and further comprising:
said capture structure including a sleeve formed by said fabric material at said upper edge, said sleeve capturing said upper mounting cord, said sleeve permitting sliding movement of said fabric member along said upper mounting cord.

4. A sunshade according to claim 2 and further comprising:
said capture structure including a set of eyelets fixed to said fabric member, said eyelets capturing said upper mounting cord, said eyelets permitting sliding movement of said fabric member along said upper mounting cord.

5. A sunshade according to claim 1 and further comprising:
said lower forward fastener including an extended flexible member joined with said fabric member, said extended flexible member including a component of releasable hook and loop fastening material.

6. A sunshade according to claim 5 and further comprising:
said lower forward fastener including a landing area suitable for mating engagement with the component of releasable hook and loop fastening material, said landing area being located on one of said fabric member and a surface of said extended flexible member.

7. A sunshade according to claim 1 and further comprising:
said fabric material being an open mesh material, the open mesh material allowing air flow through the sunshade.

8. A sunshade according to claim 1 and further comprising:
at least one of the following:
said major forward edge, said upper edge, said minor rear edge, and said lower edge;
including at least one curvilinear segment.

9. A sunshade according to claim 1 and further comprising:
said upper mounting cord including a discrete mounting cord forward segment spaced from a discrete mounting cord rear segment, said mounting cord forward segment including said upper cord forward end, said mounting cord forward segment being joined to said fabric material in spaced relationship to said upper forward fastener, said mounting cord rear segment including said upper cord rear end, said mounting cord rear segment being joined to said fabric material in spaced relationship to said upper rear fastener.

10. A sunshade configured for use on a golf cart, the golf cart having a cart body, the cart body having a front, the cart body having a rear spaced from the front in opposite relationship thereto, the cart body having a spaced pair of sides disposed in opposed parallel relationship, the pair of sides including a first side and a second side, the pair of sides extending from front to rear in general cooperation therewith, the cart body defining an open passenger compartment intermediate the pair of sides, the golf cart having a cart roof supported above the passenger compartment, the cart roof shading the passenger compartment to prevent sunlight incident thereupon from entering the passenger compartment, the cart roof being a generally planar member disposed in a generally horizontal orientation, the cart roof having a generally rectangular roof periphery, the roof periphery including a pair of opposing spaced front corners, each of the front corners being generally spaced above a respective one of the sides near the front, the roof periphery including a front edge extending between the front corners, the roof periphery including a pair of opposing spaced rear corners, each of the rear corners being generally spaced above a respective one of the sides near the rear, the roof periphery including a rear edge extending between the rear corners in generally parallel relation to the rear edge, the roof periphery including a pair of roof major edges disposed in spaced, opposing, parallel relationship, the pair of roof major edges including a first roof major edge and a second roof major edge, each of the roof major edges each extending from a front corner generally in perpendicular relation to the front edge to a rear corner generally in perpendicular relation to the rear edge, each of the roof major edges extending in generally parallel relation spaced above a corresponding side of the cart body, the golf cart having a set of roof posts extending upwardly from the cart body to support the cart roof in a fixed position, the roof posts including a pair of front roof posts each disposed near a respective front corner, the roof posts including a pair of rear roof posts each disposed near a respective rear corner, the cart body including a seat located in the passenger compartment, the seat being located forward of the rear roof posts, the seat extending generally between the spaced sides, the seat having a pair of seat ends each disposed near a respective side, the cart body having a seat arm rail supported generally above each of the seat ends, the cart body including a seat back supported for cooperation with the seat to support passengers in a seated position, the golf cart having a pair of passenger side openings, the pair of passenger side openings including a first passenger side opening and a second passenger side opening, the first passenger side opening being disposed along the first side to permit passenger ingress from the ground into the passenger compartment at the first side, the second passenger side opening being disposed along the second side to permit passenger ingress from the ground into the passenger compartment at the second side, the first passenger side opening being defined between the first roof major edge and first side of the cart body intermediate a rear roof post and front roof post, the second passenger side opening being defined between the second roof major edge and second side of the cart body intermediate a rear roof post and front roof post, each of the first and second passenger side openings permitting sunlight incident therein to enter the passenger compartment, said sunshade comprising:
a flexible fabric member configured to be temporarily affixed to a golf cart, said flexible fabric member having an inner surface facing the passenger compartment, said flexible fabric member having an outer surface disposed in opposition to said inner surface, said flexible fabric member having an outer perimeter, said flexible fabric member having a continuous forward edge, said flexible fabric member having a continuous rear edge, said forward edge being spaced from said rear edge, said flexible fabric member having a continuous upper edge, said flexible fabric member having a continuous lower edge, said lower edge being disposed in spaced opposing relationship to said upper edge;
one of said flexible fabric member and said roof edge including a component of hook and loop fastening material, the other of said flexible fabric member and said roof edge having a landing area including a mating component of the hook and loop fastening material, cooperation of said hook and loop fastening material supporting said upper edge relative to said cart roof; and
a lower fastener configured for releasable engagement with the cart body, said lower fastener being joined to said first lower corner, in the installed condition said first lower fastener being engaged with the cart body;
whereby in an installed condition said forward edge being secured in a substantially fixed position, in the installed condition said upper edge being secured in a substantially fixed position, in the installed condition said lower edge being secured in a substantially fixed position, said sunshade preventing a portion of sunlight incident upon the outer surface thereof from entering the passenger compartment.

11. A sunshade according to claim 10 and further comprising:
at least one roof bracket configured to be releasably affixed to an edge of the cart roof, the at least one roof bracket including a roof bracket landing area having a first component of hook and loop fastening material;
the flexible fabric member including at least one landing area having a second component of hook and loop fastening material, the second component mating with the first component of the roof bracket landing area to releasably support the flexible fabric member relative to the at least one roof bracket.

12. A sunshade according to claim 10 and further comprising:
a pair of roof brackets each configured to be releasably affixed to a respective edge of the cart roof, each of the roof brackets including a respective roof bracket landing area having a first component of hook and loop fastening material;
the flexible fabric member including at least a pair of landing areas each having a second component of hook and loop fastening material, the second component mating with the first component of a respective one of the roof bracket landing areas to releasably support the flexible fabric member relative to the pair of roof brackets.

13. A sunshade according to claim 10 and further comprising:
a pair of roof brackets each configured to be releasably affixed to a respective edge of the cart roof, each of the roof brackets including a respective roof bracket landing area having a first component of hook and loop fastening material;
a pair of extended flexible upper fastening members joined with said fabric member, each of said upper fastening members including an upper landing area having a second component of releasable hook and loop fastening material, the second component mating with the first component of a respective one of the roof bracket landing areas to releasably support the flexible fabric member relative to the pair of roof brackets.

14. A sunshade according to claim 10 and further comprising:
said lower fastener including an extended flexible lower fastening member joined with said fabric member, said lower fastening member including at least a first landing area, said first landing area including a first component of releasable hook and loop fastening material.

15. A sunshade according to claim 14 and further comprising:
said lower fastener including a second landing area suitable for mating engagement with the first component of releasable hook and loop fastening material, said second landing area being located on one of said fabric member and a surface of said extended flexible member, said second landing area including a second component of releasable hook and loop fastening material.

16. A sunshade according to claim 10 and further comprising:
said fabric material being an open mesh material, the open mesh material allowing air flow through the sunshade.

17. A sunshade configured for use on a golf cart, the golf cart having a cart body, the cart body having a front, the cart body having a rear spaced from the front in opposite relationship thereto, the cart body having a spaced pair of sides disposed in opposed parallel relationship, the pair of sides including a first side and a second side, the pair of sides extending from front to rear in general cooperation therewith, the cart body defining an open passenger compartment intermediate the pair of sides, the golf cart having a cart roof supported above the passenger compartment, the cart roof shading the passenger compartment to prevent sunlight incident thereupon from entering the passenger compartment, the cart roof being a generally planar member disposed in a generally horizontal orientation, the cart roof having a generally rectangular roof periphery, the roof periphery including a pair of opposing spaced front corners, each of the front corners being generally spaced above a respective one of the sides near the front, the roof periphery including a front edge extending between the front corners, the roof periphery including a pair of opposing spaced rear corners, each of the rear corners being generally spaced above a respective one of the sides near the rear, the roof periphery including a rear edge extending between the rear corners in generally parallel relation to the rear edge, the roof periphery including a pair of roof major edges disposed in spaced, opposing, parallel relationship, the pair of roof major edges including a first roof major edge and a second roof major edge, each of the roof major edges each extending from a front corner generally in perpendicular relation to the front edge to a rear corner generally in perpendicular relation to the rear edge, each of the roof major edges extending in generally parallel relation spaced above a corresponding side of the cart body, the golf cart having a set of roof posts extending upwardly from the cart body to support the cart roof in a fixed position, the roof posts including a pair of front roof posts each disposed near a respective front corner, the roof posts including a pair of rear roof posts each disposed near a respective rear corner, the cart body including a seat located in the passenger compartment, the seat being located forward of the rear roof posts, the seat extending generally between the spaced sides, the seat having a pair of seat ends each disposed near a respective side, the cart body having a seat arm rail supported generally above each of the seat ends, the cart body including a seat back supported for cooperation with the seat to support passengers in a seated position, the golf cart having a pair of passenger side openings, the pair of passenger side openings including a first passenger side opening and a second passenger side opening, the first passenger side opening being disposed along the first side to permit passenger ingress from the ground into the passenger compartment at the first side, the second passenger side opening being disposed along the second side to permit passenger ingress from the ground into the passenger compartment at the second side, the first passenger side opening being defined between the first roof major edge and first side of the cart body intermediate a rear roof post and front roof post, the second passenger side opening being defined between the second roof major edge and second side of the cart body intermediate a rear roof post and front roof post, each of the first and second passenger side openings permitting sunlight incident therein to enter the passenger compartment, said sunshade comprising:
a flexible fabric member configured to be temporarily affixed to a golf cart, said flexible fabric member having an inner surface facing the passenger compartment, said flexible fabric member having an outer surface disposed in opposition to said inner surface, said flexible fabric member having an outer perimeter, said flexible fabric member having a continuous forward edge, said flexible fabric member having a continuous rear edge, said forward edge being spaced from said rear edge, said flexible fabric member having a continuous upper edge, said flexible fabric member having a continuous lower edge, said lower edge being disposed in spaced opposing relationship to said upper edge;
a first roof bracket configured to be releasably affixed to an edge of the cart roof, the first roof bracket including a roof bracket landing area having a first component of hook and loop fastening material;
the flexible fabric member including a first landing area having second component of hook and loop fastening material, the second component mating with the first component to releasably support the flexible fabric member relative to the first roof bracket.

18. A sunshade according to claim 17 and further comprising:
a second roof bracket configured to be releasably affixed to an edge of the cart roof, the second roof bracket including a roof bracket landing area having a first component of hook and loop fastening material;
the flexible fabric member including a second landing area having second component of hook and loop fastening material, the second component mating with the first component to releasably support the flexible fabric member relative to the second roof bracket.

19. A sunshade according to claim 18 and further comprising:
the first roof bracket and second roof bracket being positioned along opposite edges of the cart roof.

20. A sunshade according to claim 17 and further comprising:
at least one lower fastener configured for releasable engagement with the cart body, in the installed condition said at least one first lower fastener being engaged with the cart body;
whereby in an installed condition an edge of said sunshade is secured in a substantially fixed position, said sunshade preventing a portion of sunlight incident upon the outer surface thereof from entering the passenger compartment.
